(19) United States
(12) Patent Application Publication
(10) Pub. No.: US 2002/0025183 A1
(43) Pub. Date: Feb. 28, 2002

(54) Toner container and method of determining abnormality of toner container

(76) Inventors: Katsuya Murakami, Shizuoka (JP); Yutaka Ban, Tokyo (JP)

Correspondence Address: FITZPATRICK CELLA HARPER & SCINTO, 30 ROCKEFELLER PLAZA, NEW YORK, NY, 10112, US

(21) Appl. No.: 09/900,944

(22) Filed: Jul. 10, 2001

(30) Foreign Application Priority Data
Jul. 12, 2000 (JP) 211299/2000
Oct. 25, 2000 (JP) 325367/2000

(51) Int. Cl. G03G 15/08

(52) U.S. Cl. 399/109; 399/263

(57) ABSTRACT

A toner container detachably mountable on an image forming apparatus includes a containing portion that contains toner therein, an agitating member that is disposed within the containing portion and agitates the toner within the containing portion, and the first and second rotating portions that rotate together with a rotary shaft of the agitating member at both end sides of the rotary shaft, the first and second rotating portions being exposed to the exterior of the containing portion, wherein the containing portion includes a first mark at a position corresponding to a predetermined position of the first rotating portion and a second mark at a position corresponding to a predetermined position of the second rotating portion.

### BACKGROUND OF THE INVENTION

1. Field of the Invention

The present invention relates to a toner container that is detachably mountable onto an image forming apparatus such as a copying machine, a printer or a facsimile machine, and a method of determining the abnormalities of the toner container.

2. Description of the Related Art

Up to now, fine powder toner has been used as a developer in an image forming apparatus such as an electrostatic copying machine or a printer. In the case where the toner in the image forming apparatus main body has been completely consumed, the toner is supplied to the image forming apparatus main body with the use of a toner supplying container detachably mountable on the image forming apparatus main body.

When toner is supplied to a main body of the image forming apparatus, an agitating and feeding member within a toner supplying container is rotated by driving force from the image forming apparatus main body to feed the toner, and the toner is discharged from an opening portion bits by bits and then supplied to the image forming apparatus main body.

The toner supplying container main body, the agitating and feeding member disposed within the toner supply container main body, and parts such as a gear which transmits a driving force to the toner supplying container main body and the agitating and feeding member are long in lifetime and useable even if the toner within the container has been completely consumed, in recent years, the container from which the toner has been supplied and completely consumed is increasingly collected and recycled.

However, the conventional toner container suffers from the following drawbacks.

In the case where the toner supplying container is stored for a long period of time or vibrated during transportation whereby air of the toner within the container is escaped and the toner is fixed with a high density, the rotation torque of the agitating and feeding member goes up, and in the worst case, the member may be deformed and damaged.

In case of recycling the above container, there is a fear in which a force is exerted on the toner due to a sliding friction between the agitating member and the inner wall of the container with the result that the toner is fused and bonded together into coarse-grained particles (coarse particles). Also, in case of a toner supplying container that uses an elastic member having the flexibility for the agitating and feeding member, and feeds and discharges the toner due to the sliding friction between the agitating and feeding member and the inner wall of the container, the sliding frictional force applied to the inner wall is weakened contrarily to the above case, and the remaining amount of toner increases.

Also, because the toner supplying container is tightly closed due to heat or ultrasonic welding after parts have been assembled in the interior of the container, and it is difficult to separate the parts of the toner supplying container, particularly in the toner supplying container small in the toner supplying opening or the toner filling inlet, there arises such a problem that it is very difficult to recognize the abnormalities of the interior of the container from which the toner has been supplied. This is a large factor that prevents the recycle of the container. For that reason, up to now, the container is destroyed, the parts are extracted from the container, and the dimensions, the configurations and the like are recognized, and then only the parts are recycled. Thus, the efficiency of the recycle is not high.

### SUMMARY OF THE INVENTION

The present invention has been made under the above circumstances, and therefore an object of the present invention is to provide a toner container which is capable of readily determining the abnormalities of the agitating member such as deformation.

Another object of the present invention is to provide a determining method which is capable of readily determining the abnormality of the agitating member such as deformation.

Still another object of the present invention will become apparent by reading the following detailed description with reference to the accompanying drawings.

These and other objects, features and advantages of the present invention will become more apparent upon consideration of the following description of the preferred embodiments of the present invention taken in conjunction with the accompanying drawings.

### BRIEF DESCRIPTION OF THE DRAWINGS

FIG. 1 is a vertical cross-sectional view showing the structure of an electrophotographic copying machine which is one example of an electrophotographic image forming apparatus onto which a toner supplying container according to the present invention is mounted;

FIG. 2 is a perspective view showing the electrophotographic copying machine;

FIG. 3 is a perspective view showing an appearance in which the toner supplying container is mounted on the electrophotographic copying machine after a cover for exchanging a toner supplying container of the electrophotographic copying machine is opened;

FIG. 4A is a perspective view showing the toner supplying container in accordance with an embodiment of the present invention viewed from a side where a sealing member is disposed, and

FIG. 4B is a perspective view showing a toner supplying container viewed from a side where a grip is disposed;

FIG. 5A is a front view showing the toner supplying container in accordance with the embodiment of the present invention,

FIG. 5B is a vertical cross-sectional view thereof,

FIG. 5C is a left side view thereof,

FIG. 5D is a right side view thereof,

FIG. 5E is a side cross-sectional view thereof, and

FIG. 5F is a plan view thereof;

FIG. 6 is a front cross-sectional view showing a state in which the toner supplying container is mounted in the apparatus main body, and the supply opening portion is unsealed;

FIG. 7 is a front cross-sectional view showing a state in which the toner supplying container is mounted in the apparatus main body, and the supply opening portion is sealed;

FIG. 8A is a perspective view showing the toner container parts in accordance with the embodiment of the present invention viewed at a side where a supply opening portion is disposed, and

FIG. 8B is a perspective view showing the toner container parts viewed from a side where the grip is disposed;

FIG. 9A is a front view showing the toner container parts,

FIG. 9B is a vertical cross-sectional view thereof,

FIG. 9C is a left side view thereof,

FIG. 9D is a right side view thereof,

FIG. 9E is a side cross-sectional view thereof, and

FIG. 9F is a plan view thereof;

FIG. 10A is a front view showing the sealing member,

FIG. 10B is a view looking in a direction of an arrow XB of FIG. 10A,

FIG. 10C is a view looking in a direction of an arrow XC of FIG. 10A, and

FIG. 10D is a front cross-sectional view thereof;

FIG. 11A is a front view showing an agitating member,

FIG. 11B is a left side view thereof, and

FIG. 11c is a right side view thereof;

FIG. 12 is an enlarged side view showing a rigid blade portion;

FIG. 13 is an enlarged view showing a flexible blade portion;

FIG. 14A is a front view showing an agitating member in accordance with another embodiment,

FIG. 14B is a left side view thereof,

FIG. 14C is a right side view thereof, and

FIG. 14D is a bottom view thereof;

FIG. 15 is a side view showing a state in which the toner supplying container is mounted on the apparatus main body;

FIG. 16 is a vertical cross-sectional view showing a detailed configuration of a first coupling member;

FIG. 17A is a vertical cross-sectional view showing the details of a gear portion,

FIG. 17B is a right side view thereof, and

FIG. 17C is a left side view thereof;

FIG. 18A is a vertical cross-sectional view showing the details of a moving member,

FIG. 18B is a right side view thereof,

FIG. 18C is a left side view thereof, and

FIG. 18D is a front view thereof;

FIG. 19 is a vertical cross-sectional view showing the detailed configuration of a second coupling member;

FIG. 20A is a front cross-sectional view showing a drive transmission claw,

FIG. 20B is a side view thereof,

FIG. 20C is a front view thereof, and

FIG. 20D is a top view thereof;

FIG. 21A is a front cross-sectional view of a transmission member,

FIGS. 21B and 21C are side views thereof, and

FIG. 21D is a front view thereof;

FIG. 22 is a vertical cross-sectional view showing an example in which the sealing member and the transporting member are integrated together;

FIG. 23A is a font view showing the sealing member having a packing member,

FIG. 23B is a side view thereof, and

FIG. 23C is a side cross-sectional view thereof;

FIG. 24A is a front view showing the packing member at the container main body side, and

FIG. 24B is a front view showing the packing member at the sealing member side;

FIG. 25 is an enlarged side view showing the transportation member and the sealing member;

FIG. 26 is a partially enlarged view showing a right side surface of the toner supplying container in accordance with a first embodiment of the present invention;

FIGS. 27A and 27B are partially enlarged views showing the left side surface of the toner supplying container in accordance with the first embodiment of the present invention;

FIG. 28 is a partially enlarged view showing the left side surface of a toner supplying container in accordance with the first embodiment of the present invention;

FIG. 29 is a partially enlarged view showing the left side surface of a toner supplying container in accordance with a second embodiment of the present invention; and

FIG. 30 is a vertical cross-sectional view showing a toner supplying container in accordance with another applied example of the present invention.

### DETAILED DESCRIPTION OF THE PREFERRED EMBODIMENTS

Now, a description will be given in more detail of preferred embodiments of the present invention with reference to the accompanying drawings.

(First Embodiment)

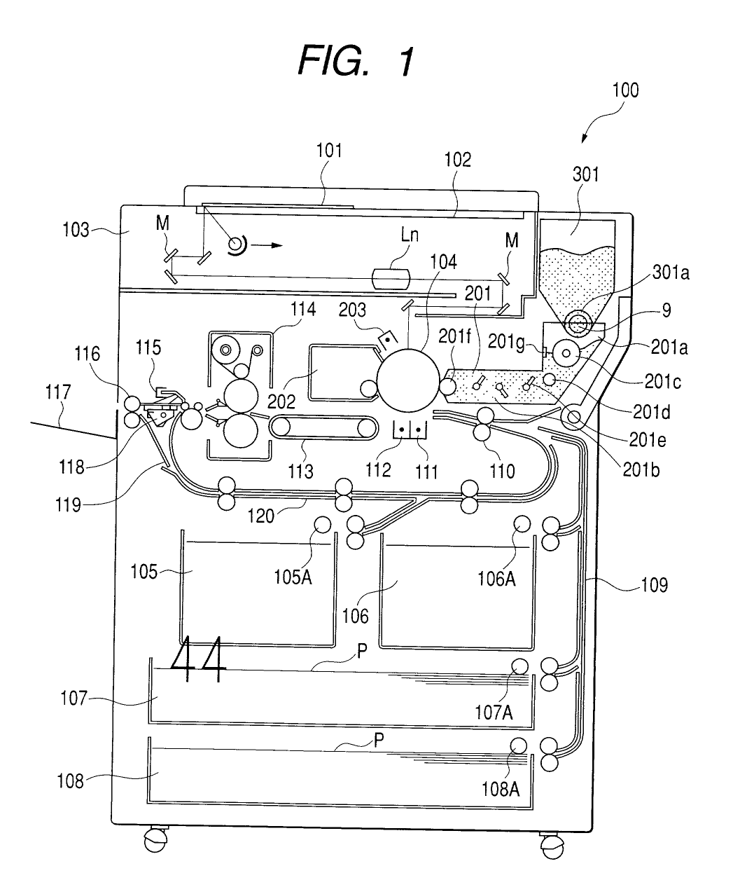

First, a description will be given of the structure of an electrophotographic copying machine which is an example of an image forming apparatus using an electrophotographic process onto which a toner supplying container (toner container) according to the present invention is mounted with reference to FIG. 1.

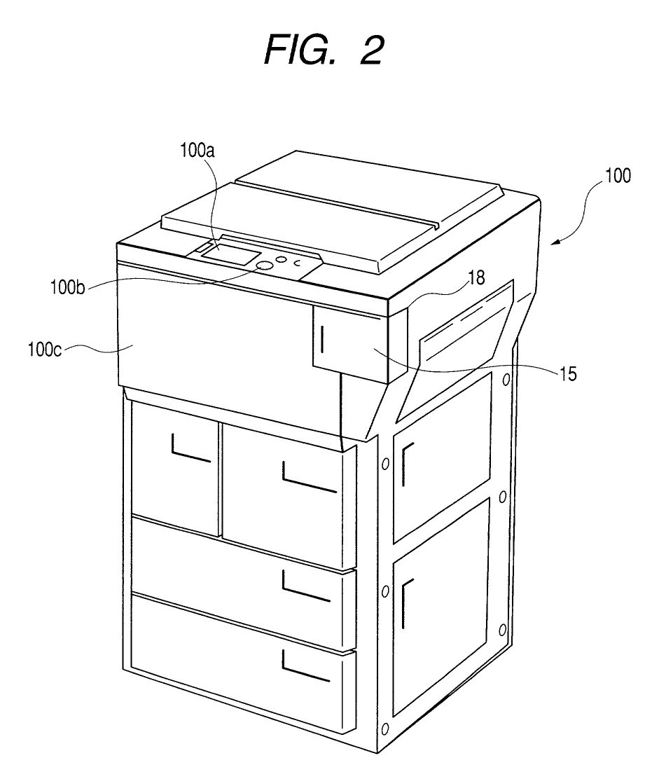

Referring to FIG. 1, reference numeral 100 denotes an electrophotographic copying machine main body (hereinafter referred to as apparatus main body). Also, reference numeral 101 denotes an original that is placed on an original glass stand 102. Then, an optical image corresponding to image information is imaged on an electrophotographic photosensitive drum 104 that serves as an image bearing member through a plurality of mirrors M and a lens Ln in an optical portion 103. Reference numeral 105 to 108 denote cassettes. An appropriate sheet is selected from the sheet size information of the cassettes 105 to 108 out of recording medium (hereinafter referred to as sheet) P loaded in those cassettes 105 to 108 on the basis of information inputted from an operating portion 100a in FIG. 2 by a user or a paper size of the original 101. In this example, the recording medium P is not limited to the sheet of paper, but for example, an OHP sheet or the like can be appropriately selected. Reference numeral 100b denotes an indicating means that indicates an operated command, a state of the image forming apparatus or the like.

Then, a single sheet P conveyed from sheet feed and separating devices 105A to 108A is conveyed to a registration roller 110 through a transporting portion 109, and further conveyed while the rotation of the photosensitive drum 104 and the timing of scanning of the optical portion 103 are synchronized with each other. Reference numeral 111 and 112 denote a transfer discharger and a separation discharger. In this example, a toner image formed on the photosensitive drum 104 is transferred onto the sheet P by the transfer discharger 111. Then, the sheet P onto which the toner image has been transferred is separated from the photosensitive drum 104 by the separation discharger 112.

Thereafter, after a toner image has been fixed on the sheet P transported by a transporting portion 113 due to heat and pressure in the fixing portion 114, in case of one-side copying, the sheet P passes through a delivery turn-over portion 115 and is then delivered to a delivery tray 117 through a delivery roller 116. Also, in case of two-side copying, after the sheet P has been transported to the registration roller 110 through re-feeding transport paths 119 and 120, the sheet P is delivered to the delivery tray 117 through the same path as that in case of the one-side copying.

Also, in case of multi-copying, the sheets P pass through the delivery turn-over portion 115 and a part of the sheets P is delivered out of the apparatus by the delivery roller 116 once. Thereafter, a trailing edge of the sheet P passes through a flapper 118 and is then transported to the interior of the apparatus again by controlling the flapper 118 at a timing when the sheet P is yet nipped by the delivery roller 116 while reversing the delivery roller 116. Further, thereafter, after the sheet p has been transported to the registration roller 110 through re-feeding transport paths 119 and 120, the sheet P is delivered to the delivery tray 117 through the same path as that in case of one-side copying.

Note that, in the apparatus main body 100 thus structured, a developing portion 201 that serves as a developing means, a cleaning device 202, a primary charger 203 and the like are disposed in the periphery of the photosensitive drum 104. In this example, the developing portion 201 is so designed as to develop an electrostatic latent image formed on the photosensitive drum 104 by the optical portion 103 on the basis of the information on the original 101 by using toner.

Then, a toner supplying container 301 that serves as a toner container for supplying the toner to the developing portion 201 is detachably mounted on the apparatus main body 100 by the user.

In this example, the developing portion 201 has a toner hopper 201a and a developing device 201b. The toner hopper 201a includes an agitating member 201c with a screw blade 201g for agitating the toner supplied from a toner supply opening portion 301a of the toner supplying container 301 through a toner receiving port 9. Then, the toner agitated by the agitating member 201c is fed to the developing device 201b by a magnet roller 201d. The developing device 201b has a developing roller 201f and a carrying member 201e. Then, the toner fed from the toner hopper 201a by the magnet roller 201d is fed to the developing roller 201f by the feeding member 201e and then supplied to the photosensitive drum 104 by the developing roller 201f.

The cleaning device 202 is so designed as to remove the toner remaining in the photosensitive drum 104. Also, the primary charger 203 is so designed as to charge the photosensitive drum 104.

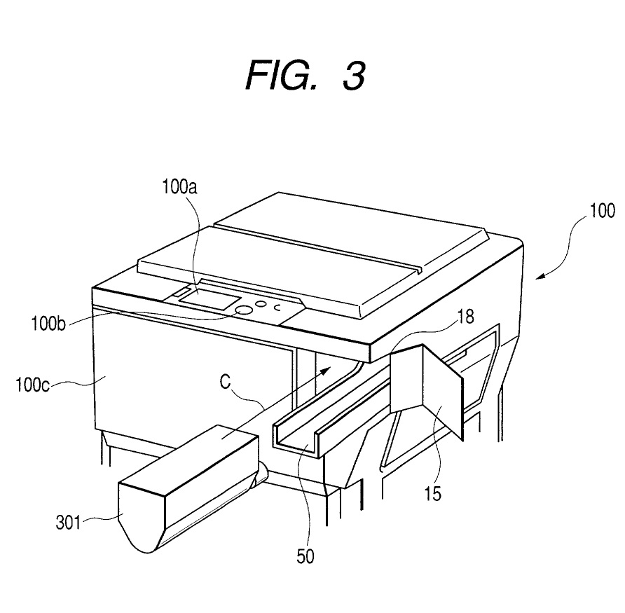

When a toner supplying container exchange cover 15 (hereinafter referred to as “exchange cover”) which is a part of an outer packaging cover that is pivotally supported to the apparatus main body 100 by a hinge 18 shown in FIG. 2 is opened by the user as shown in FIG. 3, a container receiving table 50 is drawn to a predetermined position by a driving system (not shown). Then, the toner supplying container 301 is inserted on the container receiving table 50 in a direction indicated by an arrow C and mounted. When the user takes out the toner supplying container 301 from the apparatus main body 100, the toner supplying container 301 put on the drawn container receiving table 50 is extracted. In this example, the exchange cover 15 is opened and closed only for detaching and attaching the toner supplying container 301. Note that the maintenance of the apparatus main body 100 is conducted by opening/closing the front cover 100c.

Also, it is possible that the toner supplying container 301 is mounted on the apparatus main body 100 not through the container receiving table 50 but directly, and also taken out from the apparatus main body 100.

Also, in this embodiment, all of the toner is not supplied to the image forming apparatus main body side together in a state where the toner supplying container is mounted on the image forming apparatus main body, but the toner is appropriately supplied in accordance with the consumption of the toner in the developing portion.

(The entire structure of toner supplying container)

Subsequently, the toner supplying container according to this embodiment will be described. In this embodiment, the toner feeding member and the toner agitating member are disposed in the interior of the toner supplying container.

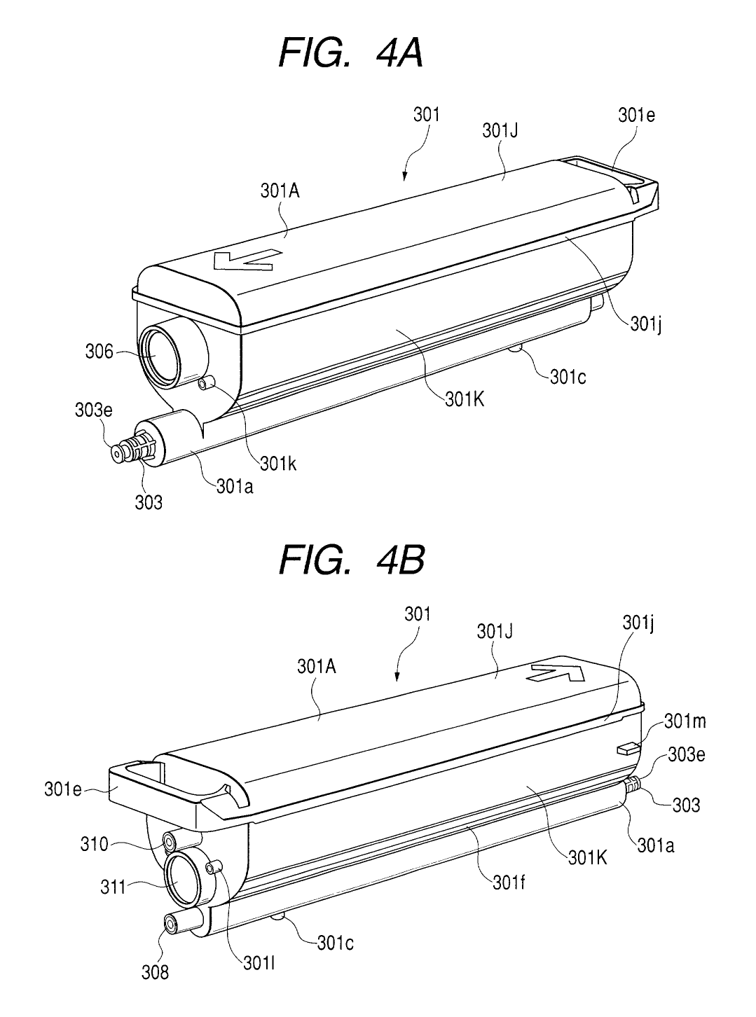

FIGS. 4A and 4B are perspective views showing the toner supplying container 301 in accordance with this embodiment.

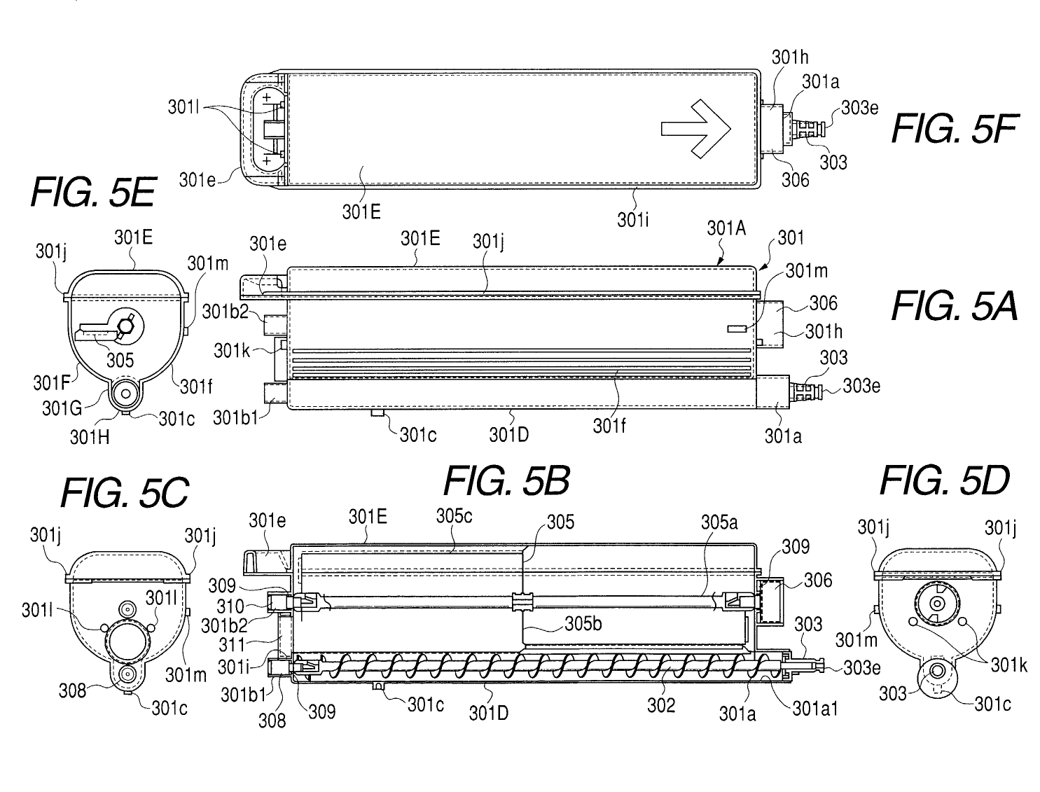

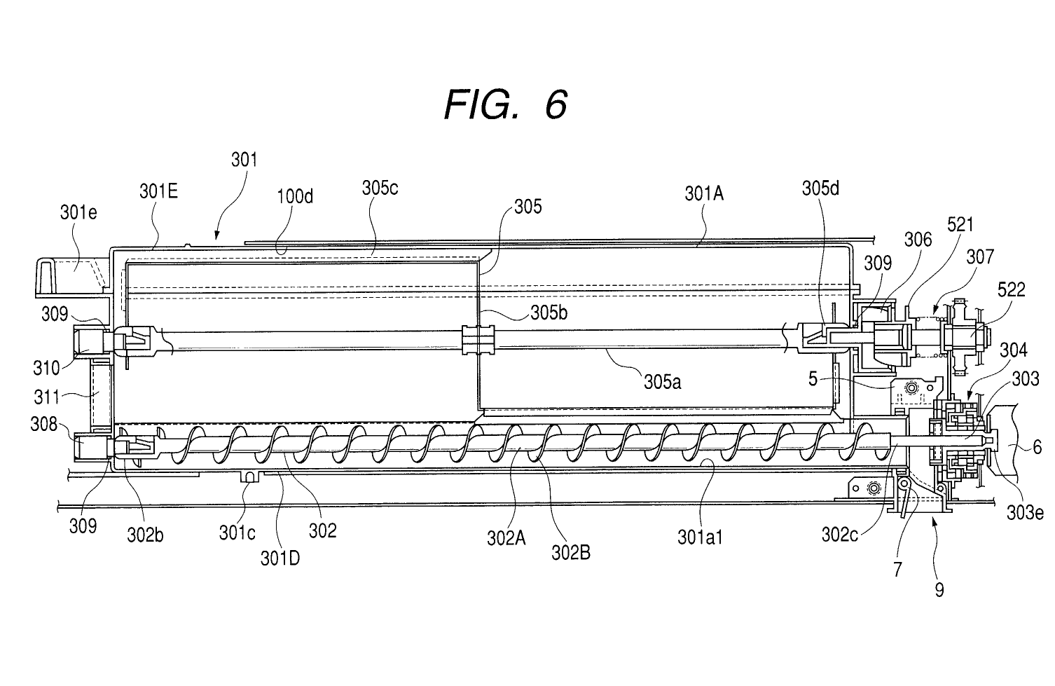

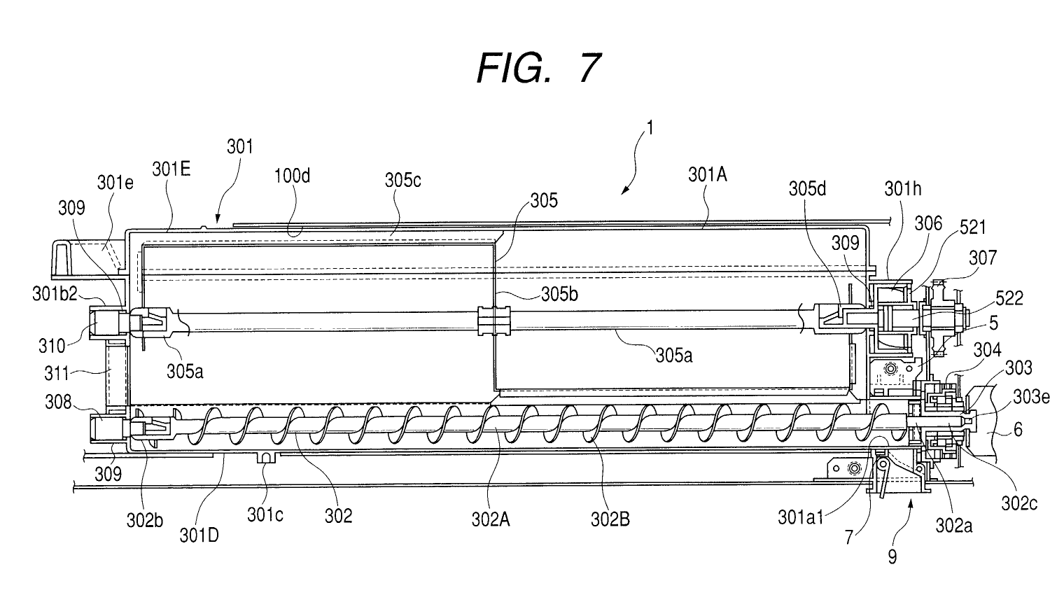

FIG. 5A is a front view showing the toner supplying container in accordance with this embodiment, FIG. 5B is a cross-sectional view of the toner supplying container, FIG. 5C is a left side view of the toner supplying container, FIG. 5D is a right side view of the toner supplying container, FIG. 5E is a side cross-sectional view of the toner supplying container, and FIG. 5F is a plan view of the toner supplying container. FIG. 6 is a front cross-sectional view showing a state in which the toner supplying container is mounted in the apparatus main body 100, and the supply opening portion is unsealed. FIG. 7 is a front cross-sectional view showing a state in which the toner supplying container is mounted in the apparatus main body 100, and the supply opening portion is sealed.

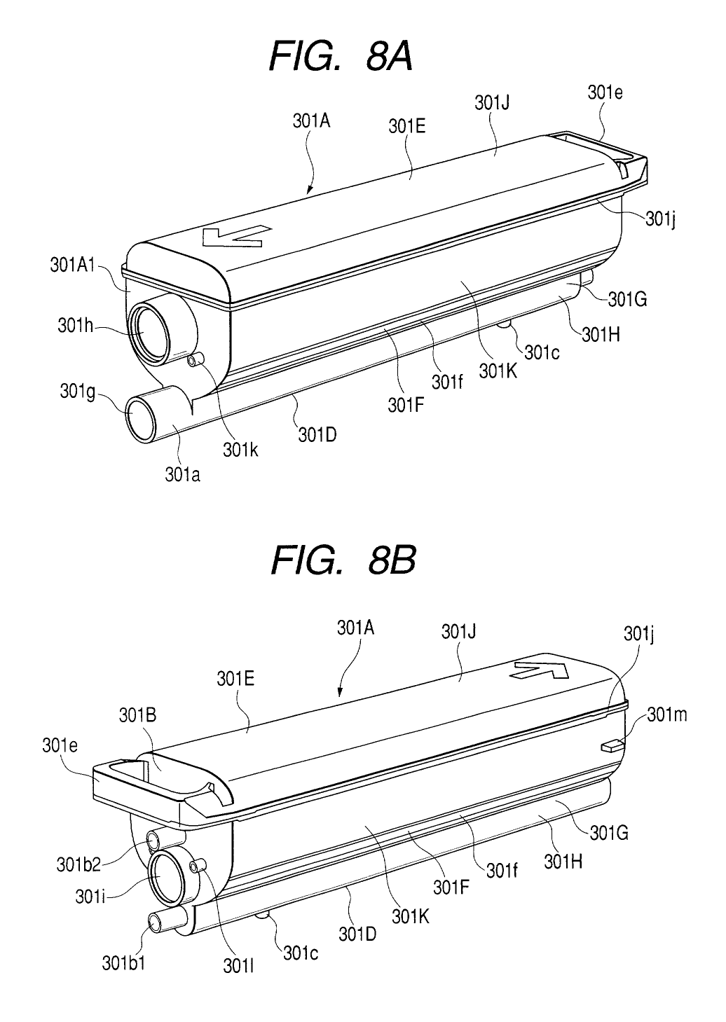

Referring to FIGS. 4A to 7, reference numeral 301A denotes a container main body that serves as a containing portion, 302 is a feeding member for feeding the toner received in the container main body 301A in a direction of the toner supply opening portion 301a. The feeding member 302 is formed of a screw having a screw blade. Reference numeral 303 denotes a sealing member for sealing the toner supplying port 301g shown in FIG. 8A, and reference numeral 304 shown in FIG. 6 is a coupling member for transmitting a drive force to the sealing member 303 when the toner supplying container 301 is mounted in the apparatus main body 100. Reference numeral 305 denotes a rotary type agitating member (hereinafter referred to as “agitating member”) for agitating the toner within the container main body 301A. A rotating portion 306 is engaged with a rotary shaft of the agitating member 305 so as to rotate together with the rotary shaft and has a transmitting portion that transmits the rotary drive force from the image forming apparatus to the rotary shaft of the agitating member 305. Reference numeral 307 denotes a second coupling member that transmits the rotary drive force to the transmitting portion 306 when the toner supplying container 301 is mounted in the apparatus main body 100. Also, the transmitting portion 306 has an engaging portion that is engaged with the second coupling member.

Also, reference numeral 309 denotes an oil seal that serves as a packing member for preventing the leakage of the toner.

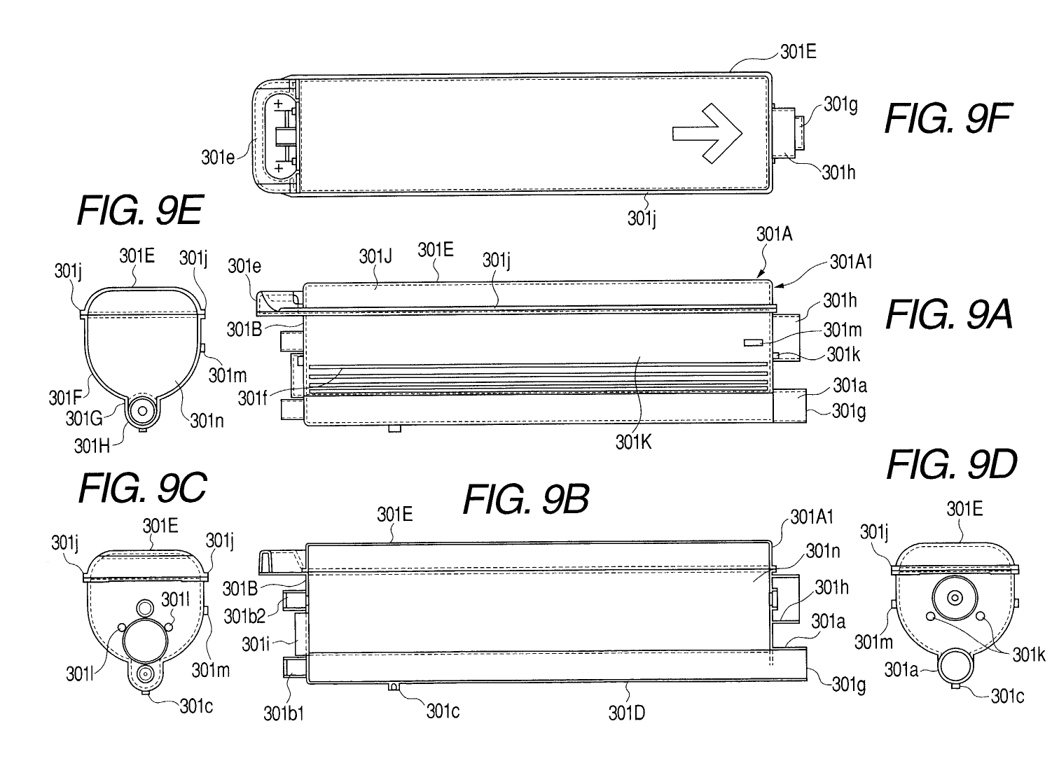

In this example, the toner supplying container parts which is the toner supplying container main body 301A will be described with reference to FIGS. 8A, 8B and 9A to 9F. FIGS. 8A and 8B are perspective views showing the container main body.

Also, FIG. 9A is a front view showing the toner container parts, FIG. 9B is a cross-sectional view thereof, FIG. 9C is a left side view thereof, FIG. 9D is a right side view thereof, FIG. 9E is a side cross-sectional view thereof, and FIG. 9F is a plan view thereof.

The toner supplying container main body 301A includes a curved portion 301F having a width which is narrower toward the lower portion, a linear portion 301G having a substantially constant width disposed on the lower portion of the curved portion, and a semicircular portion 301H which is substantially semicircular and disposed on the lower portion of the linear portion 301G.

It is preferable that the container main body 301A is manufactured using resin such as plastic through an integral molding method such as an injection molding, a blow molding or an injection blow molding. However, other materials or manufacturing methods may be applied. In other words, the container main body 301A may be manufactured through a method in which the container main body 301A is divided into two pieces or more for convenience, and those pieces are integrated together by a welding, bonding or other means.

A cylindrical toner supplying opening portion 301a for supplying the toner contained in the toner containing portion 301n to the apparatus main body is projected from a lower portion of one side surface 301A1 which is a wall surface of the container main body 301A which crosses the rotary axis of the agitating member 305. Also, the toner supplying port 301g is disposed on one end portion of the toner supply opening portion 301a.

Also, a first receiving portion 301b1 for rotatably holding the feeding member 302 is formed at a position of the other side surface 301B corresponding to the toner supply opening portion 301a. In addition, a positioning portion 301c positioned by the apparatus main body 100 when the toner supplying container 301 is mounted in the apparatus main body 100 is disposed on the outer side of the lower surface 301D. The positioning portion 301c also functions as an engaging portion 301c for moving the toner supplying container 301 which is engaged with a toner supply port open/close means (not shown) of the container receiving table 50 disposed in the apparatus main body 100 in an attaching/detaching direction.

In this embodiment, the engaging portion 301c is formed of a dowel that projects from the lower surface 301D toward the outer side. Also, the upper surface 301E is equipped with a grip 301e which is gripped by the user when the toner supplying container 301 is mounted in the apparatus main body 100 or is taken out from the apparatus main body 100. Also, on the downward inclined surface (curved portion) 301F of the front surface and the back surface, a groove 301f for making it easy to catch the container main body 301A when the user mounts the toner supplying container 301 in the apparatus main body 100 is formed substantially in parallel with the longitudinal direction of the container main body 301A. The curved portion 301F is formed of a part of a cylinder that centers a shaft portion 302A of the feeding member 302.

Also, a second receiving portion 301b2 for rotatably supporting the agitating member 305 is disposed above the first receiving portion 301b1 of the other side surface 301B.

In this example, the toner supply opening portion 301a is disposed along a side surface 301A1 opposite to a side surface 301B at which the grip 301e is disposed along the longitudinal direction of the container main body 301A. Therefore, the user can be prevented from unintentionally touching the toner supply opening portion 301a when the user mounts the toner supplying container 301 in the apparatus main body 100. Also, the toner supply opening portion 301a is disposed below the side surface 301A1. Therefore, even if the toner contained in the container main body 301A is lessened, the toner can be efficiently discharged.

In this example, the toner supply opening portion 301a is projected from one side surface 301A1 by 20 to 40 mm, preferably about 27.8 mm. Also, the toner supply opening portion 301a is cylindrical and the outer diameter of the cylindrical portion is 20 mm to 30 mm, preferably 26 mm to 29 mm, more preferably about 27.6 mm.

Also, as described above, the outer side of the lower surface 301D is provided with the engaging portion 301c. The engaging portion 301c is positioned by an engaging portion disposed in the apparatus main body 100 when the toner supplying container 301 is mounted in the apparatus main body 100. As described above, the engaging portion 301c is a cylindrical dowel that projects from the lower surface 301D toward the exterior. The outer diameter of the cylindrical portion is 5 mm to 12 mm, preferably about 8 mm. Also, the engaging portion 301c is positioned at 2 mm to 8 mm from the lower surface 301D, and the engaging portion 301c (positioning portion) is disposed at a position of 60 mm to 80 mm, preferably about 71 mm from a side end surface opposite to a side where the toner supply opening portion 301a is positioned in the longitudinal direction of the lower surface 301D.

The engaging portion (positioning portion) 301c is preferably cylindrical, but may be rectangular-columnar or semi-circular.

Note that on one side surface 301A1 and the other side surface 301B are disposed two bosses 301k and 3011 for positioning the container main body 301A when testing the dimensions of the container main body 301A before shipping from a factory, respectively.

Also, reference numeral 301m is a rib for prevention of a mounting error.

With the provision of the ribs 301m at different positions for each of the toner supplying containers 301, the user can be prevented from mounting another kind of toner supplying container in the apparatus main body 100.

It is preferable that the container main body 301A is manufactured using resin such as plastic through an integral molding method such as an injection molding, a blow molding or an injection blow molding. However, other materials or manufacturing methods may be applied. Further, the container main body 301A may be manufactured through a method in which the container main body 301A is divided into two pieces or more for convenience, and those pieces are integrated together by a welding, bonding or other means.

In this embodiment, the container main body 301A is manufactured by vibration-welding two frames consisting of an upper frame and a lower frame which have been injection-molded with high impact polystyrene.

Also, the feeding member 302 includes the shaft portion 302A and a spiral-shaped and rigid feed blade 302B that is disposed on the shaft portion 302A and functions as a feeding portion which feeds the powder toner in a predetermined direction by the rotation of the shaft portion 302A as shown in FIG. 6. Then, the feeding member 302 is attached to the container main body 301A in a state where the axis line of the shaft portion 302A substantially coincides with the center of the toner supplying portion 301g which is substantially circular.

Note that the feeding member 302 is not limited to a so-called screw type which was described in this embodiment, but may be applied to the shaft portion 302A to which a flexible blade is fitted. Also, the shaft portion and the blade may be integrally molded or separated. In this embodiment, the shaft portion 302A and the blade 302B are integrally molded with plastic.

Further, in this embodiment, the feeding member 302 has an extending portion 302c that exists in the interior of the cylindrical portion of the toner supply opening portion 301a as shown in FIG. 7. In this embodiment, the extending portion 302c is further projected toward the external of the toner supply opening portion 301a. Then, the leading edge portion projected toward the exterior of the extending portion 302c receives the rotary drive force from the apparatus main body 100. For that reason, in this embodiment, the sealing member 303 is movably attached to the leading portion in the axial direction.

In this example, one end portion (drive force receiving portion) 302a of the extending portion 302c is so shaped as to receive the rotary drive force from the apparatus main body 100 through the sealing member 303. In this embodiment, the one end portion 302a is polygonal in section, in particular, rectangular. Then, one end portion of the shaft portion 302A is supported by the sealing member 303 through the one end portion 302a of the extending portion 302c. Also, a first bearing member 308 is disposed in the other end portion 302b of the shaft portion 302A. Then, the feeding member 302 is rotatably supported to the container main body 301A through the first bearing member 308.

Also, the feeding member 302 is supported to the sealing member 303 in a state where the feeding blade 302B is out of the inner wall 301a1 of the toner supply opening portion 301a and in a state where the inner wall surface 301a1 of the toner supply opening portion 301a and one end portion 302a of the shaft portion 302A are substantially horizontal. Then, with the supporting of the feeding member 302 in this way, the feeding member 302 is rotated, thereby making it possible to feed the toner toward the toner supply portion 301g substantially horizontally. Also, it can be prevented that the fine toner is involved between the inner wall surface 301a1 of the toner supply opening portion 301a and the feeding blade 302B, and then strongly subjected to sliding friction, to thereby allow the toner to be melted and fixed onto the inner wall surface 301a1, and the coarse powders occur.

As described above, it is preferable that the feeding member 302 is also manufactured through an injection molding method or the like using a resin such as plastic because this method is simple. However, other materials or other manufacturing methods may be applied. Also, division and bonding may be arbitrarily made for manufacturing.

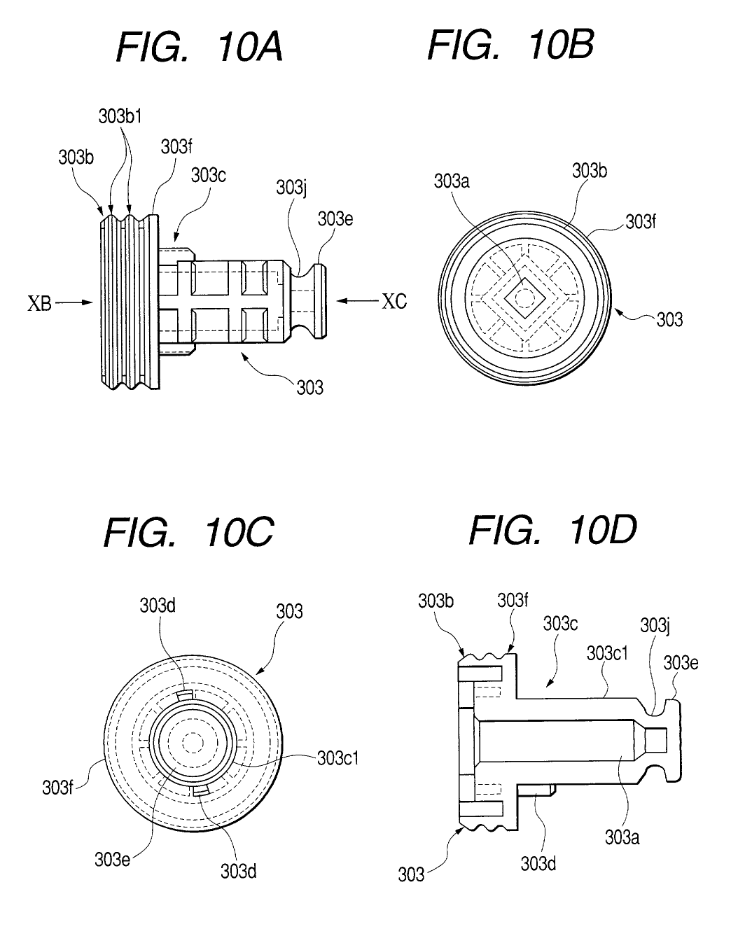

Then, the sealing member 303 will be described with reference to FIGS. 10A to 10D. FIG. 10A is a front view showing the sealing member, FIG. 10B is a view looking in the direction of the arrow XB of FIG. 10A, FIG. 10C is a view looking in the direction of the arrow XC of FIG. 10A, and FIG. 10D is a front cross-sectional view thereof.

Referring to FIGS. 10A, 10B and 10D, reference numeral 303b denotes a sealing portion that is disposed at a side of the sealing member 303 opposite to the toner supplying container 301 and unsealably seals the toner supply port 301g of the toner supplying container 301. The sealing portion 303b is designed such that the outer diameter is set to be larger than the inner diameter of the toner supply portion 301g by an appropriate amount. Then, the fitting portion 303b1 of the protruded threads in the peripheral direction of the sealing portion 303b is force-fitted into the toner supply opening portion 301a from the toner supply port 301g, with the result that the sealing member 303 seals the toner supply port 301g.

Also, reference numeral 303c denotes a coupling engaging portion that functions as a drive force transmitted portion (drive portion) for receiving a drive force used to rotate the feeding member 302 from the apparatus main body 100 when the toner supplying container 301 is mounted in the apparatus main body 100. The coupling engaging portion 303c has a projecting portion 303c1 that extends on the substantially same axis line as that of the shaft portion 302A of the feeding member 302 in a direction opposite to the toner container main body 301A from the sealing portion 303b when the sealing member 303 is mounted to the container main body 301A. Also, the coupling engaging portion 303c has a slender (spline shaped) protrusion (rib) 303d that functions as a drive force receiving portion which is engaged with the coupling member 304. In this embodiment, two spline protrusions 303d are disposed at a substantially regular interval.

Specifically, two splines are disposed at an interval of about 1800 with the longitudinal direction of the sealing member 303 as a center.

Also, the rib 303d is radially projected from the projected portion 303c1 of the sealing member 303 by 0.5 mm to 3 mm, preferably about 1.8 mm.

Also, the outer diameter of the projected portion 303c1 is set to 10 mm to 14 mm, preferably about 12 mm.

Incidentally, the sealing member 303 has an engaging hole 303a as a drive force transmitting portion for transmitting the drive force received from the apparatus main body 100 by engagement with the one end portion 302a of the feeding member 302 to the feeding member 302. The engaging hole 303a is made up of openings (cavity portions) formed over a portion where the sealing portion 303b and the coupling engaging portion 303c are formed. In this example, the engaging hole 303a has a rectangular shape corresponding to the rectangular shape of the axial end portion 302a of the feeding member 302 which projects from the toner supply opening portion 301a. Then, the engaging hole 303a is so formed as to be larger than the axial end portion 302a, with the result that the axial end portion 302a is loosely fitted into the engaging hole 303a.

Then, the axial end portion 302a is loosely fitted into the engaging hole 303a in this way, whereby the feeding member 302 and the sealing member 303 are engaged with each other in the rotating direction of the feeding member 302. On the other hand, the feeding member 302 and the sealing member 303 are movable to each other in the axial direction. As a result, when the toner supplying container is mounted onto the apparatus main body, the sealing member 303 and the container main body 301A can be apart from each other, thereby making it possible unseal (open) the toner supply port 301g.

Incidentally, the engagement length of the engaging hole 303a and the axial end portion 302a is to a degree in which the engaging hole 303a and the axial end portion 302a are not separated from each other when the sealing member 303 and the container main body 301A are apart from each other. As a result, even if the sealing member 303 is apart from the container main body 301A, the feeding member 302 can receive the drive force through the sealing member 303 (coupling engaging portion 303c).

Also, a collar portion 303f that abuts against the end portion of the toner supply opening portion 301a when the sealing portion 303b is force-fitted into the toner supply opening portion 301a is disposed between the coupling engaging portion 303c and the sealing portion 303b. The outer diameter of the collar portion 303f is substantially equal to the outer diameter of the toner supply opening portion 301a (preferably, smaller than the outer diameter of the toner supply opening portion 301a). The sealing portion 303b is force-fitted into the toner supply opening 301a by the collar portion 303f by a length as long as the sealing portion 303b.

On the other hand, reference numeral 303e denotes an engaging protrusion 303e which functions as an engaging portion which is formed in a leading end of the coupling engaging portion 303c and engaged with the engaging member 6 disposed in the apparatus main body (refer to FIG. 6). The engaging member 6 is engaged with the engaging protrusion 303e, thereby making it possible to fix the sealing member 303 when the toner supply port 301g is unsealed.

Incidentally, it is preferable that the sealing member 303 thus structured is manufactured by injection molding with a resin such as plastic, but other materials or manufacturing methods may be applied and division and bonding may be arbitrarily made for manufacturing. Also, the sealing member 303 is required to provide an appropriate elasticity because the sealing member 303 is force-fitted into the toner supply opening portion 301a and tightly seals the toner supply opening portion 301a. The material is most preferably low-density polyethylene, and more preferably polypropylene, nylon, high-density polyethylene and the like.

Note that reference numeral 303j denotes a peripheral engaging groove fitted into the engaging member 6 disposed in the apparatus main body 100. The width of the engaging groove 303j is set to 1.5 mm to 5 mm, preferably about 3 mm. Also, the depth of the engaging groove 303j is set to 0.5 mm to 5 mm, preferably about 2.5 mm.

As described above, the sealing member 303 has a substantially cylindrical fitting portion 303b1 which is fitted into the toner supply opening portion 301a. Then, the sealing member 303 has a collar portion 303f on substantially the same axis line as that of the fitting portion 303b1. In addition, the sealing member 303 has a projecting portion 303c1 that projects on substantially the same axis line of that of the fitting portion 303b1 on a side opposite to a side where the fitting portion 303b1 is disposed from the collar portion 303f, and a protrusion 303d of the drive force receiving portion is disposed on the base of the projecting portion 303c1. Also, the leading edge portion of the projecting portion 303c1 in the projecting direction is provided with an engaging groove 303j, and the leading end is provided with an engaging portion 303e. Also, the sealing member 303 has a cavity portion extending from the fitting portion 303b1 side toward the engaging portion 303e side, and an engaging hole 303a is defined in the cavity portion as the drive force transmitting portion. Since the engaging portion 303e side of the cavity portion is not opened, there is no case in which the toner that has entered the cavity portion is leaked to the exterior of the container main body 301A when the fitting portion 303b1 is fitted into the toner supply opening portion 303a. Therefore, the toner supply opening portion 301a is sealed by fitting the sealing member 303.

In this embodiment, the sealing member 303 has the following four functions.

That is, 1) a function of sealing the toner supply opening portion 301a; 2) a function of receiving the transmission of a rotary drive force from the apparatus main body 100; 3) a function of transmitting the rotary drive force to the feeding member 302; and 4) a function of engaging with the engaging member 6 disposed in the apparatus main body 100 for opening and closing the toner supply opening portion 301a. Therefore, the drive force received by the sealing member 303 from the apparatus main body 100 is transmitted to the shaft portion 302A through the extending portion 302c, thereby making it possible to rotate the feeding member 302.

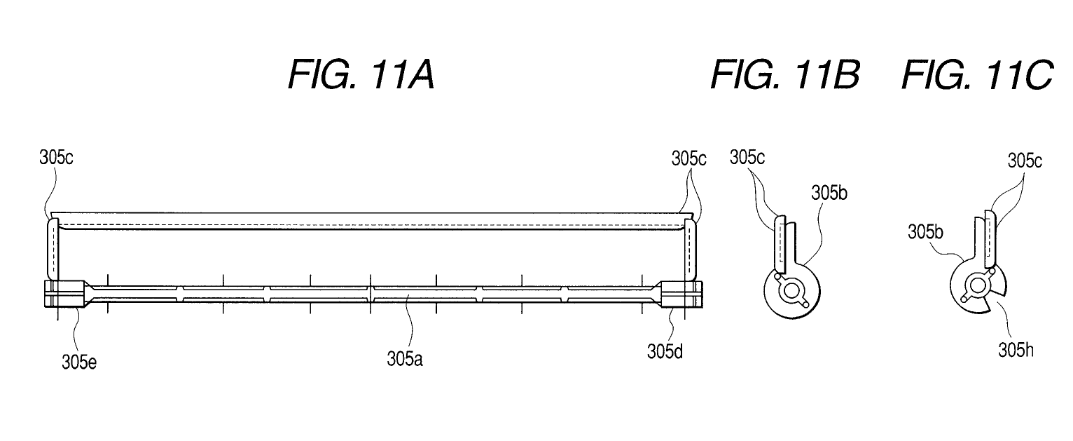

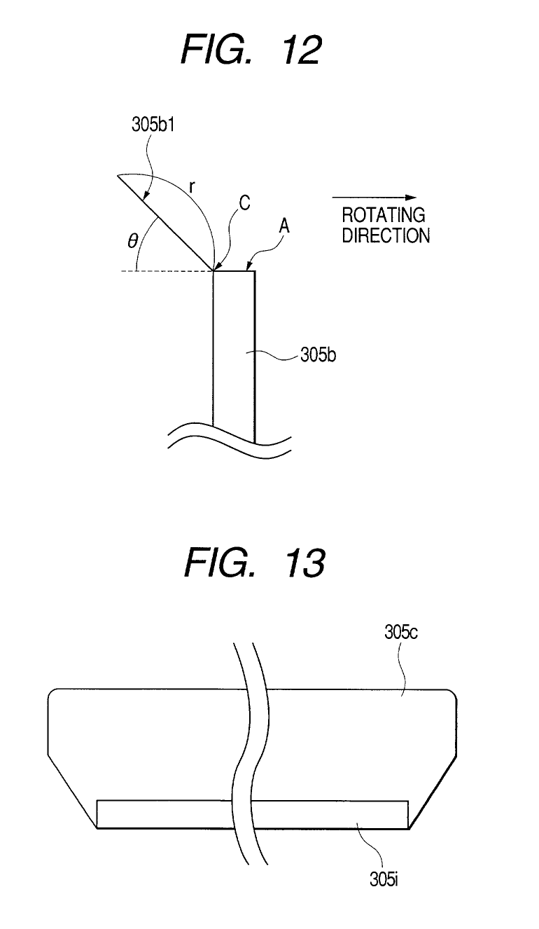

Then, the agitating member 305 will be described. FIG. 11A is a front view showing an agitating member, FIG. 11B is a right side view thereof, and FIG. 11C is a left side view thereof. As shown in FIGS. 11A to 11C, the agitating member 305 has an shaft portion 305a and a rigid wing portion 305b and a flexible wing portion 305c which serve as the agitating portion. Also, FIG. 12 shows an enlarged side view of the rigid wing portion 305 and FIG. 13 is an enlarged view of the flexible wing portion 305c. The shaft portion 305a is manufactured by injection molding plastic relatively high in rigidity. The rigid wing portion 305b is made of a metal such as stainless or a material very high in rigidity, and the flexible wing portion 305c is made of a material low in rigidity, for example, a plastic film or sheet, or an elastmer sheet. In this embodiment, a polyester sheet is used.

In the bearing portion 301h of the toner supplying container main body 301A, one end 305d of the agitating member 305 is engaged with the above-mentioned transmitting member 306. Also, the other end 305e of the rotary shaft of the agitating member 305d is engaged with a stopper member (second bearing member) 310 that serves as a rotary portion that rotates together with the rotary shaft of the agitating member in the second receiving portion 301b2 of the toner supplying container main body 301A. Also, the shaft portion 305a is formed by injection molding a plastic relatively high in rigidity in this embodiment, but a material such as metal may be employed.

It is preferable that the rigid wing portion 305b is integrally formed with metal or the like because it is simple. However, other materials or manufacturing methods may be applied, and the rigid wing portion 305b may be divided into two pieces or more, and those pieces may be integrated together by a welding, bonding or other means. In this embodiment, the rigid wing portion 305b is formed of a stainless plate about 0.8 mm in thickness which has been pressed. Also, the engaging portion of the rigid wing portion 305b with the shaft portion 305a is so shaped as to correspond to the shaft portion 305a to receive the drive from the shaft portion 305a. The rigid wing portion 305b rotates together with the rotary motion of the shaft portion 305a and agitates the toner within the container while being in contact with the inner wall of the container.

In this situation, when a notch 305h is formed on one end of the rigid wing portion 305b as shown in FIG. 11C, assembling is more facilitated. In addition, a portion which is in parallel with the shaft portion 305a of the rigid wing portion 305b is plate-shaped so as to be substantially in parallel with the tangent direction to the rotary locus over the entire length. The downstream side of the wing portion in the rotating direction is bent toward the toner supplying container 301 inner wall side. It is preferable that the length r of the bent portion 305b1 shown in FIG. 12 is set to about 2 mm to 8 mm, and a bent angle θ is set to 30° to 50°. More preferably, the length r of the bent portion 305b1 is set to about 3 mm to 5 mm, and the bent angle θ is set to about 45°.

In this embodiment, the length of the bent portion 305b1 is set to about 5 mm, and the bent angle is set to about 45°. A distance from the center of the rotary axis to the leading end of the rigid wing portion is appropriately determined in accordance with the size of the container main body 301A, but may be preferably set to be about 70 to 95% of the inner radius of the container main body. In this embodiment, since the inner radius of the container main body is about 44.5 mm, it is set to about 39.4 mm (89%). The bent portion 301b1 of the rigid wing portion 305b is apart from the inner wall surface of the container main body 301A.

The flexible wing portion 305c is made of a material low in rigidity, for example, a flexible member such as a sheet of PET (polyethylene terephthalate), PE (polyethylene), PP (polypropylene) or PPS (polyphenylene sulfide). The thickness of the flexible wing portion 305c is preferably set to about 50 to 500 μm, and more particularly 100 to 300 μm. In this embodiment, a polyester sheet of about 100 μm in thickness is used.

The flexible wing portion 305c is stuck onto the entire length of the bent portion 305b1 of the rigid wing portion 305b in such a manner that the leading end is in contact with the inner wall surface of the container main body. Then, the flexible wing portion 305c rotates while scrapping off the toner from the container inner wall surface in cooperation with the rigid wing portion 305b. The length of the flexible wing portion 305c in the rotation radius direction and the length of the flexible wind portion 305c in the wall surface direction which is substantially in parallel with the rotary axis are so set to be longer than a distance from the leading edge of the rigid wing portion 305b to the container inner wall surface by about 0.5 mm to 10 mm. With this structure, the above-mentioned effect in which the amount of toner that remains in the toner supplying container when the use of the toner has been completed is lessened can be further enhanced.

As described above, the structure in which the length of the flexible wing portion 305c in the rotation radius direction and the length of the flexible wind portion 305c in the wall surface direction which is substantially in parallel with the rotary axis are so set to be longer than a distance from the leading edge of the rigid wing portion 305b to the container inner wall surface means that the agitating blade enters the container wall surface (the inner walls of the curved portion 301F, one side surface 301A1, and the other side surface 301B).

In this embodiment, the radial length of the flexible wing portion 305c is set to be longer than the distance from the leading edge of the rigid wing portion 305b to the container inner wall surface by about 6 mm. Also, in this embodiment, the adhesive of the rigid wing portion 305b and the flexible wing portion 305c is made in such a manner that an adhesive double coated tape 305i (product mark DIC #8800CH) is stuck onto the bent portion 305b of the rigid wing portion 305b as shown in FIG. 13. Alternatively, a well-known means such as riveting or caulking may be used, or the flexible wing portion 305c may be molded integrally with the rigid wing portion 305b.

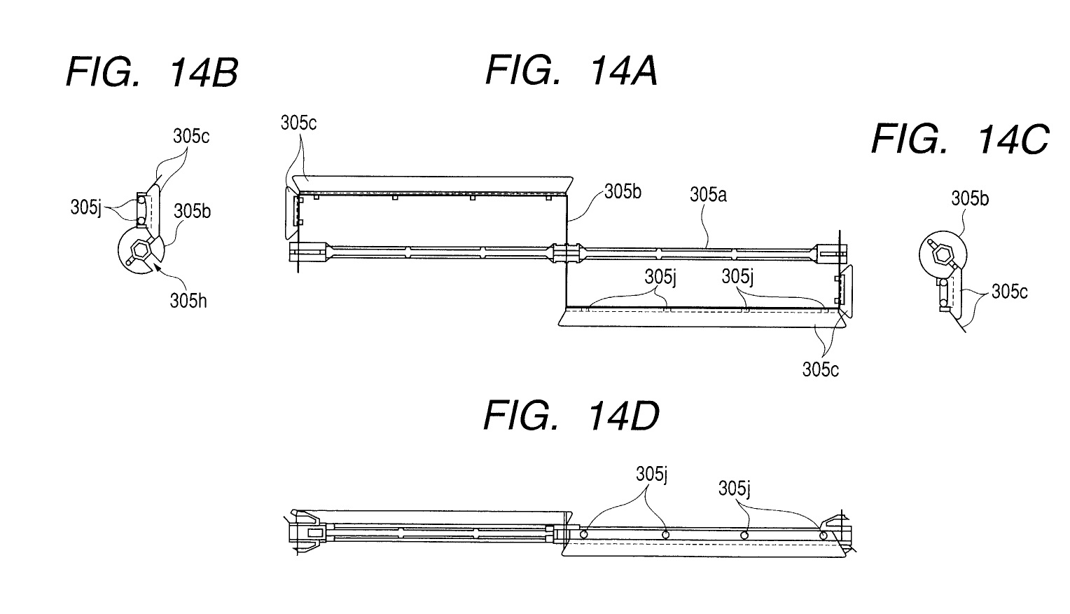

Also, as shown in FIGS. 14A to 14D, there is shown an example in which the rigid wing portion 305b is divided at the substantially center portion so as to provide a phase difference of 180 degrees with respect to the axial direction so as to be shaped into a zigzag. In this example, the number of divisions may be appropriately determined in accordance with the shape and the length of the container main body, and the rigid wing portion 305b may be divided into three pieces or four pieces or more in the longitudinal direction or in the peripheral direction. Also, the rigid wing portion 305b may be continuously changed in phase over the entire longitudinal length into a spiral shape. Also, if a notch 305h is formed in the engaging portion of both end portions of the rigid wing portion 305b and the shaft portion on substantially the center portion thereof as shown in FIG. 14B, to thereby improve the assembling property. In order to make the projection area of the rigid wing portion 305b in the rotational direction small and reduce the resistance of the toner, the length of the rigid wing portion bent portion 305b1 is set to about 3 mm. The length r and the bent angle e of the bent portion 305b1 are preferably set to about 2 to 8 mm and about 30 to 50 degrees, and more preferably about 3 to 5 mm and about 45 degrees.

Also, as a mean for bonding the rigid wing portion 305b and the flexible wing portion 305c, the adhesive double coated tape may be replaced by an aluminum rivet 305i for caulking. In this example, since flapping may occur if the rivet hole of the flexible wing portion 305c is even slightly displaced, a portion of the flexible wing portion 305c which abuts against the bent portion 305b1 of the rigid wing portion 305b may be scored or half-cut. Also, as a sticking means, other conventional method such as the adhesive double coated tape may be applied.

Subsequently, a method of assembling the toner supplying container 301 will be described.

In a method of assembling the toner supplying container 301, the feeding member 302 is first inserted into the lower portion of the lower frame 301k from the upper. Then, after the oil seal 309 has been inserted into the first receiving portion 301b1, the bearing member 308 is engaged with the other end portion 302b of the feeding member 302. In addition, the toner supply port 301g is sealed with the sealing member 303.

Then, the agitating member 305 is inserted from the upper. Then, after the oil seal 309 has been inserted into the container main body 301A, the second bearing member 310 and the transmitting member 306 are engaged with both ends of the agitating member 305. Thereafter, the upper frame 301J is vibration-welted with the lower frame 301k.

Then, a given amount of toner is filled in the interior of the container main body 301A through the toner filling port 301i of the toner supplying container 301 main body, and the toner filling port 301i is sealed with the sealing member 311 to complete the assembling. In this way, the assembling of the toner supplying container 301 is extremely simple, and the number of assembling processes is also very reduced.

The filling of the toner may be conducted by the toner supply port 301g.

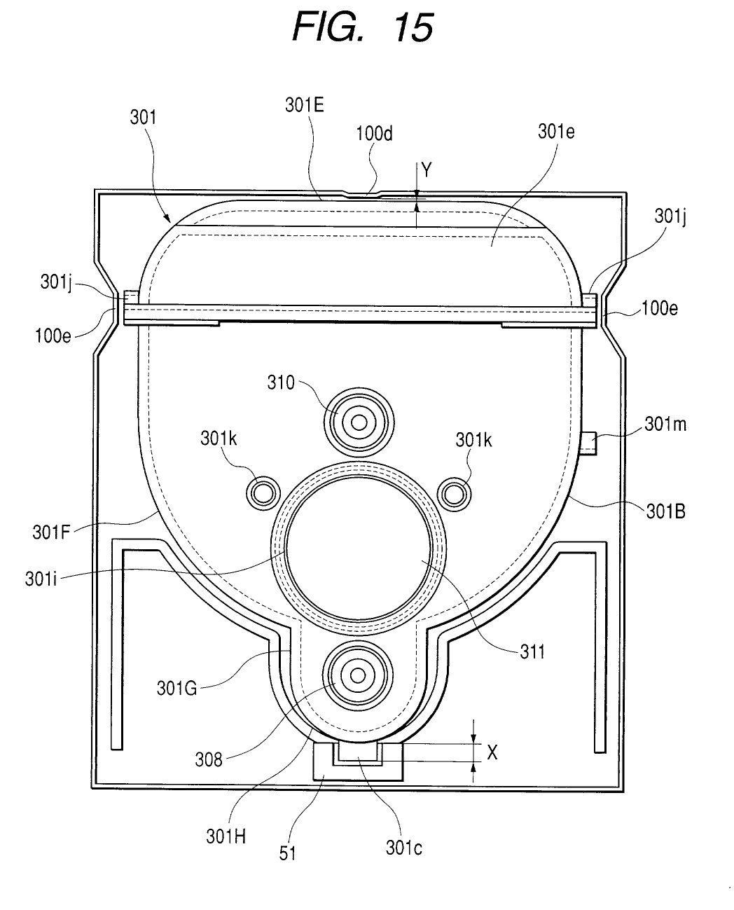

When the toner supply opening portion 301a has been unsealed by the above-mentioned toner supply portion open/close means, in the container main body 301A, a force is applied to the toner supply opening portion 301a and the engaging protrusion 301c (refer to FIG. 15). The force is a force of mainly drawing the sealing member 303 from the toner supply opening 301a. In this situation, as described above, since the engaging protrusion 301c is disposed at a side opposite to the side where the toner supply opening portion 301a is positioned in the longitudinal direction of the lower surface of the container main body 301A, lift of the container main body 301A with respect to the apparatus main body 100 can be suppressed. Note that if the container main body 301A lifts up, the upper surface 301E is abutted against the ceiling surface 100d (refer to FIG. 15) disposed on the apparatus main body 100, thereby making it possible to prevent the container main body 301A from moving upward by a given distance or more.

Also, it is desirable that the engaging protrusion 301c and the toner supply port 301g of the toner supplying container 301 are disposed on the same perpendicular line with respect to the slide direction of the toner supplying container 301 as shown in FIG. 15. With this structure, any moment in the right and left directions can be prevented from occurring in the toner supplying container 301 with respect to the slide direction in FIG. 15. Even if the moment in any direction occurs, the ribs 301i that serves as the laterally regulating portion disposed on the side surface 301A1 and the other side surface 301B are abutted against the side wall portion 100e disposed on the apparatus main body 100, thereby making it possible to prevent the container main body 301A from moving in the lateral direction by longer than a given distance.

Incidentally, the height of the engaging protrusion 301c of the toner supplying container 301 is set in such a manner that in order to prevent the toner supplying container 301 from falling upward during the slide movement, the engaging margin X (refer to FIG. 15) of the engaging protrusion 301c and the engaging portion 51 which is a container chucking member is set to be larger than a clearance Y (refer to FIG. 15) of the container upper surface 301E and the ceiling portion 100d of the apparatus main body 100.

Also, in order to take up any play or stop, it is desirable that the ribs 301j of the toner supplying container 301 in the right and left direction in FIG. 15 is disposed on the upper portion of the toner supplying container 301, and in this embodiment, the ribs 301j are so disposed as to be higher than the center portion of the toner supplying container 301 in the heightwise direction with an appropriate clearance therebetween.

Subsequently, the drive mechanism of the toner supplying container 301 according to this embodiment will be described.

When the toner supplying container 301 is mounted on the apparatus main body, the coupling engaging portion 303c of the sealing member 303 shown in FIG. 10A is engaged with the first coupling member 304 at the apparatus main body 100 side as shown in FIG. 6. In this example, the first coupling member 304 is so designed as to transmit the drive force of the drive device (not shown) disposed at the apparatus main body 100 side to the sealing member 303.

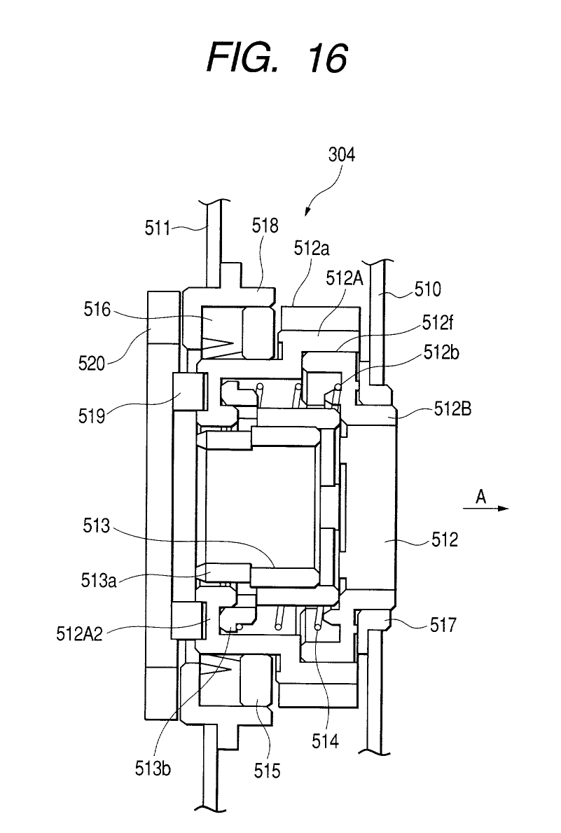

FIG. 16 is a view showing the detailed shape of the first coupling member 304.

Reference numeral 512 denotes a gear member having an outer peripheral surface 512a formed with the tooth portions of a gear. The gear tooth of the outer peripheral surface 512a are engaged with the gears (not shown) continuous to the drive source of the apparatus main body 100. The gear member 512 is made up of two members consisting of a gear portion 512A and a cap portion 512B, and those portions 512A and 512B are fixed to each other at the fitting portion 512f through snap fitting, bonding or the like. The interior of the gear member 512 is equipped with an urging means 514 and a moving member 513. The urging means 514 is abutted against a spring seat 512b of the gear member 512 and a spring seat 513b of the moving member 513. The urging means 514 is formed of a compression coil.

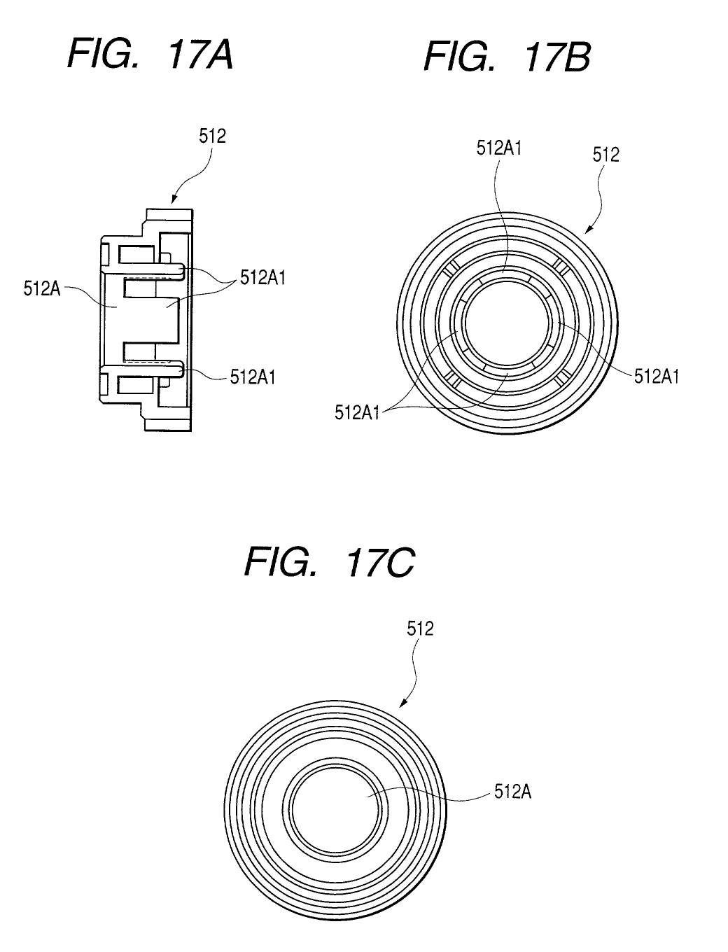

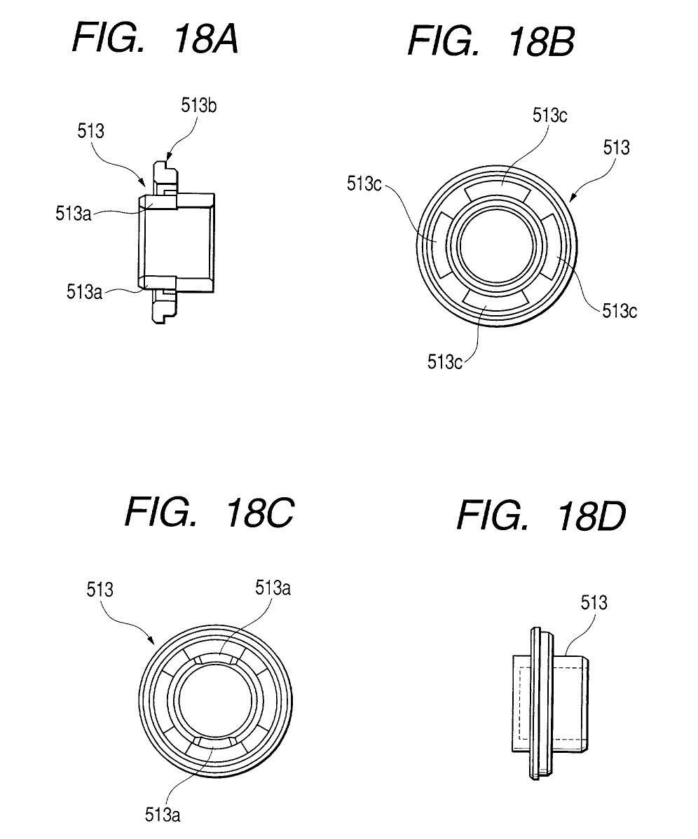

FIGS. 17A to 17C are views showing the details of the gear portion 512A, in which FIG. 17A is a front cross-sectional view thereof, and FIGS. 17B and 17C are side views thereof. Also, FIGS. 18A to 18D are views showing the details of the moving member 513, in which FIG. 18A is a front cross-sectional view thereof, FIGS. 18B and 18C are side views thereof, and FIG. 18D is a front view thereof.

In FIGS. 17A and B, the gear portion 512A has four slide guiding ribs 512A1 which face the axial direction in the direction of circumference at equal intervals. In FIG. 18B, the moving member 513 has four slide guiding holes 513c in the direction of circumference at equal intervals. The moving member 513 can slide in the axial direction in the inner portion of the gear member 512 by being engaged with the above-mentioned slide guide ribs 512A1 of the gear portion 512A.

In the moving member 513, reference numeral 513a denotes a grooved drive transmitting portion. In a state where the toner supplying container 301 is mounted on the apparatus main body 100, the drive transmitting portion 513a is engaged with the slender protrusion 303d (refer to FIGS. 10C and 10D) of the sealing member 303, and transmits the rotation drive to the sealing member 303.

Referring to FIG. 16, reference numeral 517 and 515 denote bearing members that rotatably support the gear member 512. Reference numeral 516 denotes an oil seat. The oil seal 516 is fitted to a bearing holder 518 so that the rip is in contact with the leftmost outer periphery of the gear portion 512A. The oil seat 516 prevents the toner discharged from the toner supply port 301g from entering the bearing members 515 and 517 to lock the gear member 512. Reference numeral 519 denotes a gear packing member which is fixed to the left side of the gear portion 512A. In a state where the toner supplying container 301 is mounted on the apparatus main body 100, the gear packing member 519 is brought in press contact with the sealing member 303, to thereby prevent the toner discharged from the toner supply portion 301g from entering the gear member 512. Reference numeral 510 and 511 denote drive side plates that support the first coupling member 304. The drive side plate 510 is fitted into the bearing member 517. The drive side plate 511 is fitted into the bearing holder 518. The drive side plates 510 and 511 denote members fixed to the apparatus main body 100. The bearing holder 518 holds the bearing 515 and the oil packing 516 and is fixed to the drive side plate 511 by a small screw or an adhesive. Reference numeral 520 denotes a holder packing member which is fixed to the left end surface of the bearing holder 518. The holder packing member 520 shown in FIG. 16 prevents the toner from being leaked from a space between the holder 5 and the bearing holder 518 shown in FIG. 6. The holder 5 is a member that constitutes a toner receiving port 9. The holder 5 forms a passage for supplying the toner between the toner supply port 301g and the toner receiving port 9.

The gear packing member 519 and the holder packing member 520 are fixed to the gear member 512 and the bearing holder 518 by the adhesive double coated tape or the like, respectively, and made of a material having an elasticity such as a foamed urethane.

Then, the operation of the first coupling member 304 will be described. The moving member 513 of the first coupling member 304 is so structured as to be movable axially with respect to the slide guide rib 512A1 which was described with reference to FIG. 17A, thereby being capable of retracting in a direction indicated by an arrow A in FIG. 16. The moving member 513 is usually urged at a position where the spring seat 513b is abutted against the end plate 512A2 of the gear portion 512A by the urging means 514 as shown in FIG. 16. When the toner supplying container 301 is mounted on the apparatus main body 100, the sealing member 303 enters the first coupling member 304 as shown in FIG. 7. In this situation, when the protrusion 303d of the sealing member 303 and the drive transmitting portion 513a of the moving member 513 are in phase, the protrusion 303d is fitted into the drive transmitting portion 513a. Then, the gear member 512 and the drive member 513 rotate due to the drive of the main body not shown, and the sealing member 303 is rotated through the drive transmitting portion 513a. When the protrusion 303d of the sealing member 303 and the drive transmitting portion 513a of the moving member 513 are out of phase, the moving member 513 is pressed against the urging means 514 due to the protrusion 303d of the sealing member 303 in the direction indicated by the arrow A in FIG. 16. Then, when the gear member 512 and the moving member 513 rotate due to the drive portion of the main body, the moving member 513 runs idle until the protrusion 303d of the sealing member 303 and the drive transmitting portion 513a of the moving member 513 are in phase. Then, when they are in phase, the moving member 513 slides due to the urging means 514 till a state where the drive transmitting portion 513a and the slender protrusion 303d of the sealing member 303 are engaged with each other, and then transmits the drive to the sealing member 303.

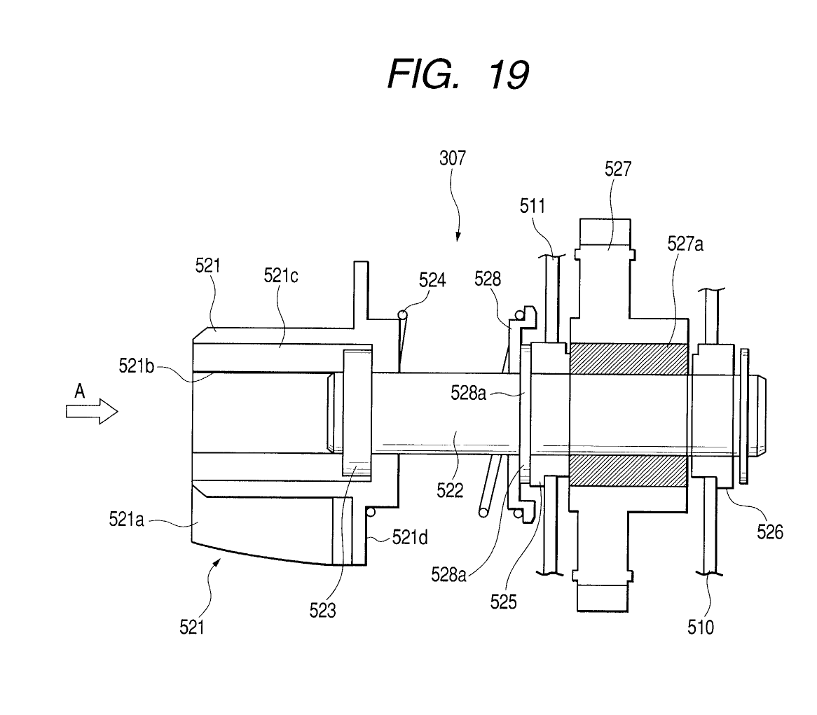

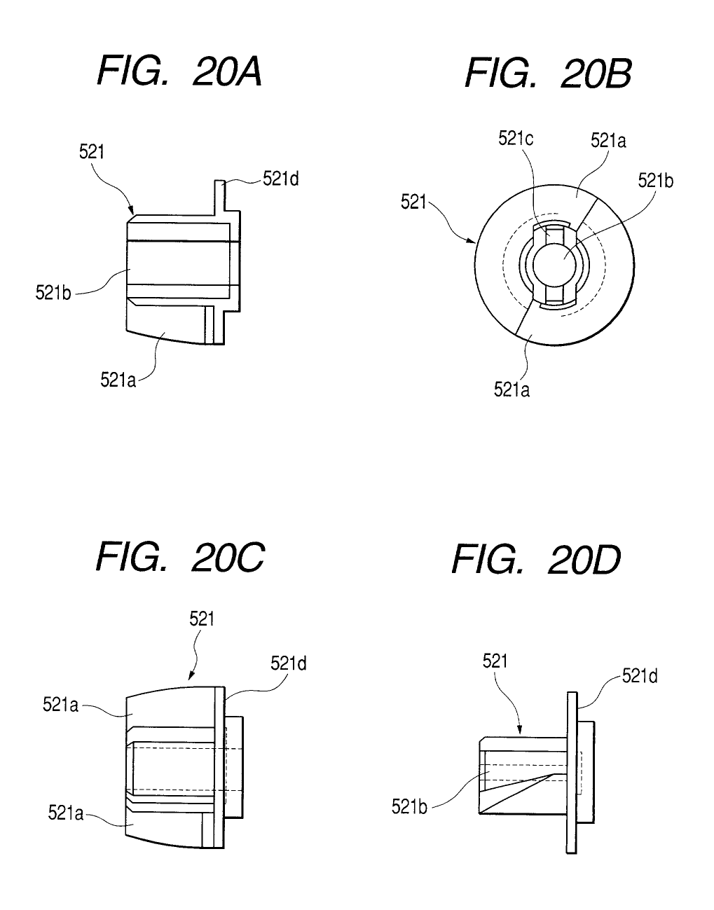

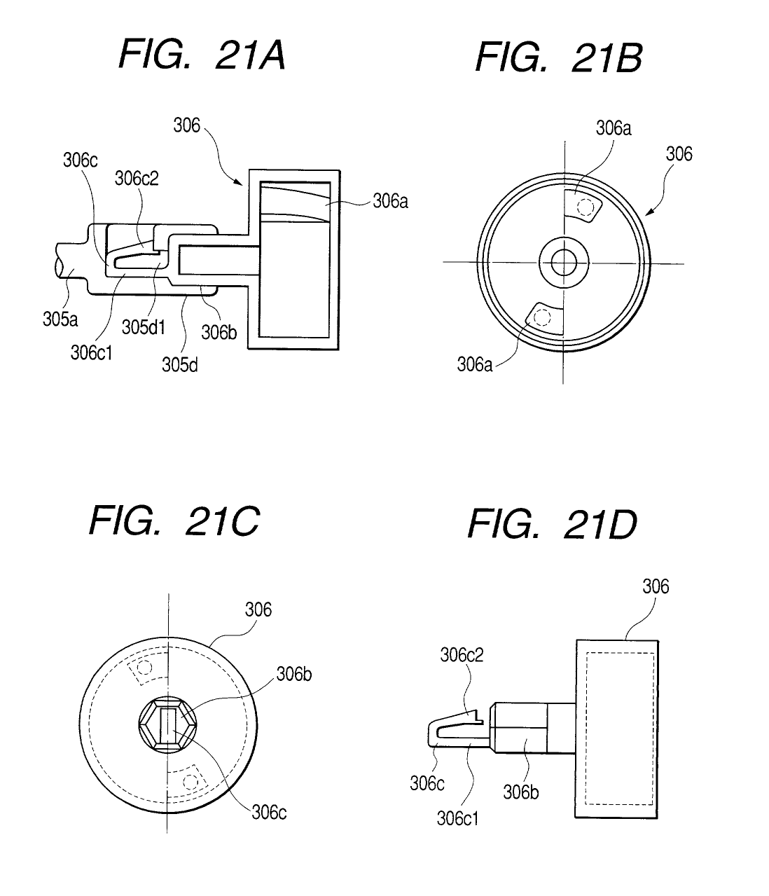

FIG. 19 is a diagram showing the detailed shape of the second coupling member 307. Reference numeral 521 denotes a drive transmission claw. FIG. 20A is a front cross-sectional view showing the drive transmitting claw 521, FIG. 20B is a side view thereof, FIG. 20C is a front view thereof, and FIG. 20D is a top view thereof. Referring to FIGS. 20A to 20D, reference numeral 521a denotes a claw portion, 521b is a slide guide portion, 521c is a parallel pin groove portion, 521d is a spring receiving surface. In this example, the claw portion 521a is twisted in accordance with the axial direction. FIGS. 21A to 21D are views showing the details of the transmitting member 306 shown in FIG. 6, in which FIG. 21A is a front cross-sectional view thereof, FIGS. 21B and 21C are side views thereof, and FIG. 21D is a front view thereof. Referring to FIGS. 21A to 21D, reference numeral 306a denotes a transmitting claw portion. The transmitting claw portion 306a is twisted in accordance with the axial direction. The twisting direction is identical with that of the claw portion 521a. In this example, when the drive transmitting claw 521 rotates, the claw portion 521a and the transmitting claw portion 306a are attracted to each other.

Referring to FIG. 19, reference numeral 522 denotes a drive shaft. The drive shaft 522 is rotatably supported to the drive side plates 510 and 511 through the bearings 525 and 526. The drive shaft 522 is provided with a one-way gear 527. The one-way gear 527 is supported to the drive shaft 522 through the one-way clutch 527a (a member that only transmits rotation in a predetermined rotating direction). The drive transmitting claw 521 is freely fitted to the drive shaft 522 in the axial direction.

The drive transmitting claw 521 is slidable by engaging the slide guide portioin 521b with the drive shaft 522. In other words, the slide guide portion 521b is a cylindrical hole which is fitted to the cylindrical drive shaft 522. The parallel pint 523 is engaged with the parallel pin groove portion 521c, to thereby transmit the rotation of the drive shaft 522 to the drive transmitting claw 521. In this example, the parallel pin 523 is press-inserted into the drive shaft 522 over the diameter of the drive shaft 522. The parallel pin groove portion 521c is disposed along the generatrix of the slide guide portion 521b. Reference numeral 524 denotes an urging means which is abutted against the spring seat 528 and the spring receiving surface 521d of the drive transmitting claw 521. The spring seat 528 is fitted to the driven shaft 522 and in contact with the bearing 525 through collars 528a. The urging means 524 is a compression coil spring.

Then, the operation of the second coupling member 307 will be described. The drive transmitting claw 521 of the second coupling member 307 is movable in a direction indicated by an arrow A in FIG. 19 with the above-described structure, and usually urged by the urging means 524 at a position where the stop portion of the end portion of the parallel pin groove portion 521c of the drive transmitting claw 521 is abutted against the parallel pin 523 shown in FIG. 19. When the toner supplying container 301 is mounted in the apparatus main body 100, the transmitting member 306 is advanced to the second coupling member 307. In case of a phase where the transmitting claw portion 306a of the transmitting member 306 and the claw portion 521a of the drive transmitting claw 521 are abutted against each other, the claw portion 521a of the drive transmitting claw 521 rotates due to the transmitting claw portion 306a of the transmitting member 306. In this situation, because the driving shaft 522 also drives with the rotation of the transmitting member 306 but also runs idle at the one-way clutch 527a of the one-way gear 527, when the toner supplying container 301 is mounted on the apparatus main body 100, there is no interference of the drive transmitting claw 521 with the transmitting member 306.

In addition, in the toner supplying container that was moved from the state shown in FIG. 7 to the state shown in FIG. 6 due to the above-mentioned means, because the drive transmitting claw 521 is moved by the urging means 524 with the evacuation of the transmitting member 306 counterclockwise, the transmitting claw portion 306a of the transmitting member 306 and the claw portion 521a of the drive transmitting claw 521 continue to maintain the engaging state.

Therefore, the transmitting member 306 rotates through the one-way gear 527, the driving shaft 522 and the drive transmitting claw 521 due to the drive means of the main body not shown, and the agitating member 305 also rotates.

Then, the discharge of toner will be described.

When the toner supplying container 301 is mounted on the apparatus main body 100, the engaging protrusion 303e which serves as the engaging portion of the sealing member 303 leading end (refer to FIG. 10A) is engaged with the engaging member 6 of the image forming apparatus main body 100 as shown in FIG. 6, and the sealing member 303 is held at a position apart from the toner supply port 301g of the container main body 301A. In this situation, the engaging relation in the rotating direction between the transmitting member 302 and the sealing member 303 are held as it is.

Also, the sealing member 303 is engaged with the first coupling member 304 of the apparatus main body 100 by the coupling engaging portion (drive force receiving portion) 303c having the protrusion 303d. The first coupling member 304 receives the rotating drive through a drive transmitting means (not shown) such as a gear from a drive source (not shown) such as a motor of the apparatus main body 100, and then transmits the rotating drive to the feeding member 302 with engagement of the drive transmitting portion 513a shown in FIG. 16 with the spline-shaped protrusion 303d shown in FIGS. 10A to 10D. In addition, the first coupling member 304 transmits the rotating drive to the feeding member 302 with engagement of the engaging hole 303a with one end portion 302a of the feeding member 302. Similarly, the transmitting member 306 which is engaged with one end 305d of the agitating member 305 is engaged with the second coupling member 307 of the apparatus main body 100. The second coupling member 307 of the apparatus main body 100 receives the rotating drive from a drive source (not shown) such as a motor through a drive transmitting means (not shown) such as a gear, and the claw portion 512a of the second coupling member 307 is engaged with the transmitting claw portion 306a of the transmitting member 306 to transmit the rotating drive to the agitating member 305. The rotating speeds of the feeding member 302 and the agitating member 305 are set to be about 52 r.p.m. and about 10 r.p.m., respectively.

Upon rotation of the agitating member 305, the toner from which air has been escaped and which has agglomerated due to the vibrations during transportation and saving for a long period of time is loosened, and then fed toward the toner supply opening portion 301a due to the rotation of the feeding member 302. The toner is discharged and drops from the toner supply port 301g and then supplied to a toner hopper 201a of the apparatus main body 100 (the toner may be supplied directly to the developing device depending on the structure of the image forming apparatus).

The toner discharge experiment has been conducted using the container thus structured. The container main body 301A is filled with the toner, and the rotating speed of the agitating member 305 is set to be about 10 r.p.m. and the rotating speed of the transporting member is set to be about 52 r.p.m. to discharge the toner. Then, as a result that the amount of coarse particles occurring from the toner discharged from the container main body 301A has been recognized by using a comb (teeth spacing of 75 μm made by SUS), the occurrence of coarse particles has not been recognized. In addition, the amount of remaining toner within the main body 301A is 20 g and the effect of reducing the amount of remaining toner has been also recognized.

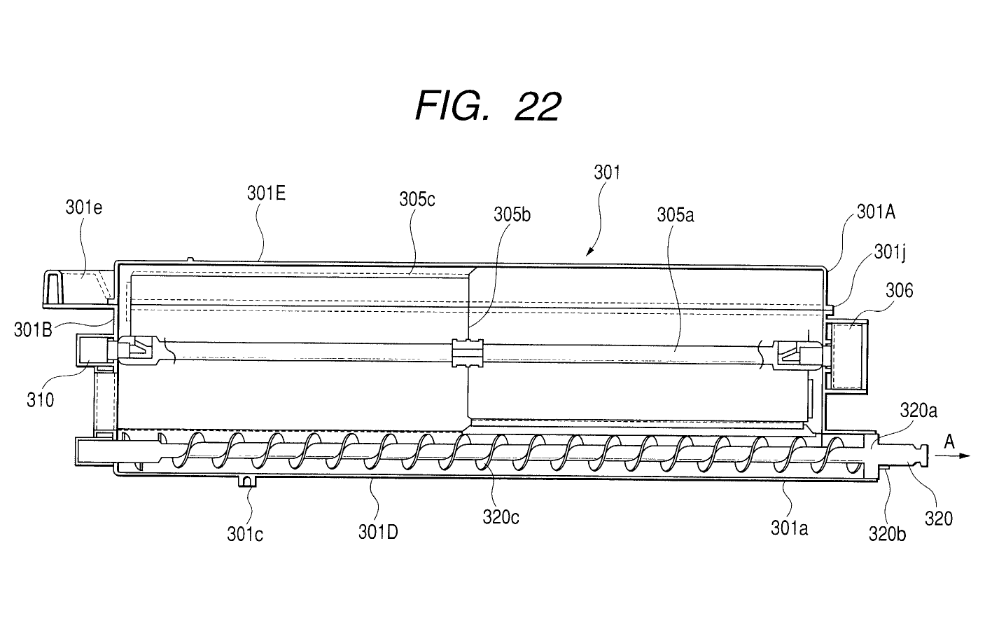

In this embodiment, the sealing member 303 is so structured as to be movable in the axial direction with respect to the feeding member 302, but the sealing member and the transporting member may be integrated with each other as shown in FIG. 22. Referring to FIG. 22, the sealing member 320 includes the sealing portion 320a, the drive force receiving portion 320b and the toner feeding portion 320c. Then, the sealing member 320 is so designed as to be movable in a direction indicated by an arrow A in FIG. 22 with respect to the container main body 301A.

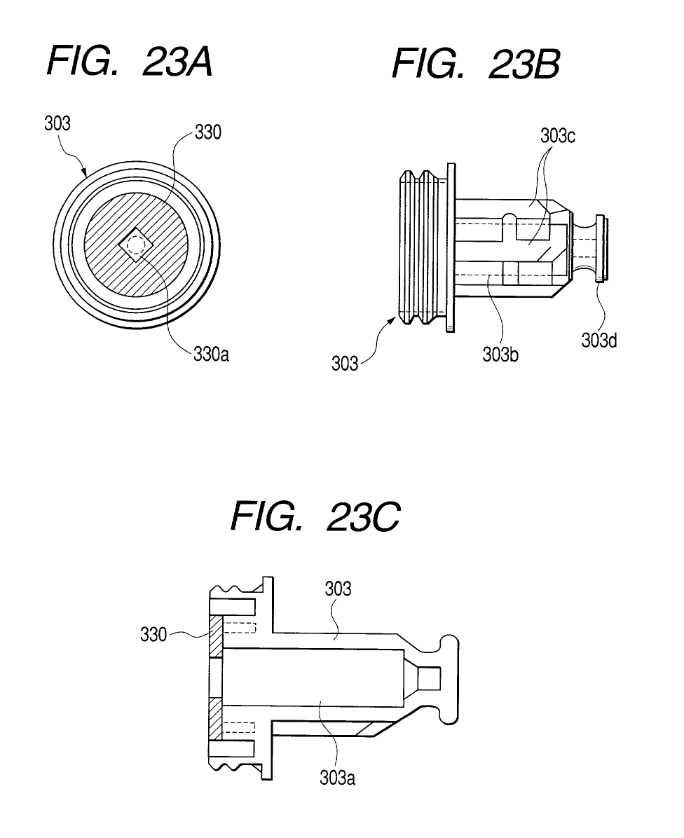

Also, a packing member may be provided in the engaging hole 303a of the drive portion (drive force transmitting portion) having the sealing member 303. FIG. 23A is a front view showing the sealing member having a packing member, FIG. 23B is a side view thereof, and FIG. 23C is a side cross-sectional view thereof.

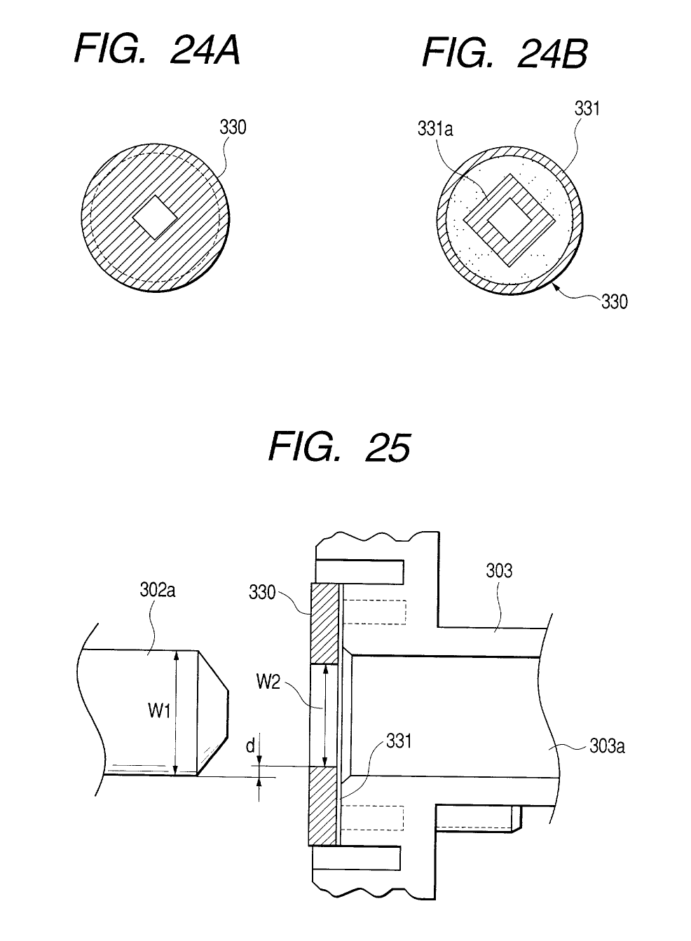

Reference numeral 330 denotes a disc-shaped packing member having a rectangular hole 330a corresponding to the shape of one end portion 302a of the shaft of the agitating member 302. In this embodiment, the cross-sectional shape of the hole 330a is square as in the axial end portion 302a. The packing member 330 is disposed at a side of the sealing member 303 opposite to the container main body 301A, and the one end portion 302a (refer to FIG. 7) of the shaft of the feeding member 302 penetrates the hole 330a so as to be loosely fitted into the hole 303a. FIGS. 24A and 24B are front views showing the packing member 330 to which the embodiment of the present invention is applied. Reference numeral 331 denotes an adhesive double coated tape which is disposed at a side of the packing member 330 opposite to the sealing member 303. The adhesive double coated tape 331 has a hole 331a and is so structured as to penetrate the hole 331a as in the hole 330a when the axial end portion 302a is loosely fitted into the hole 303a. Also, the cross-sectional shape of the hole 331a is set to be larger than the hole 330a so that the adhesive double coated tape 331 is out of the axial end portion 302a. In this embodiment, the sealing member 303 and the packing member 330 are fixed by the adhesive double coated tape, but as another fixing method, the sealing member 303 and packing member 330 may be integrated by two-color molding or insertion molding.

FIG. 25 is an enlarged side view showing the feeding member 302 and the sealing member 303 to which the embodiment of the present invention is applied. The diameter (W2) of the hole 330a is set to be smaller than the shaft diameter (W1=6 mm) of the axial end portion 302a, and specifically, it is preferable that a difference (d) between W1 and W2 is set to be 0.5 mm to 2 mm. In this embodiment, W2=5 mm, d=W1−W2=1 mm. It is preferable that the thickness of the packing member 330 is set to be 0.5 mm to 5 mm taking the sealing property and the assembling property into consideration. It is more preferable that the thickness of the packing member 330 is set to be 1 mm to 3 mm. In this embodiment, the thickness of the packing member 330 is set to be about 2 mm. The material of the packing member 330 is preferably made of a soft elastic member taking the sealing property and the assembling property into consideration, and in this embodiment, the material of the packing member 330 is made of a low-foaming polyurethane of 20° to 70° in hardness, 4% or less in compression permanent distortion, μ=0.8 or less in frictional coefficient, 60 to 300 μm in cell size and 0.2 to 0.5 in specific weight.

The toner supplying container 1 thus structured is filled with the toner, and the rotating speed of the agitating member 305 is set to 25 r.p.m. and the toner is discharged, and thereafter the sealing member 303 is continuously opened and closed. As a result, even after having 200 times of the open/close operation, the toner does not enter the depth of the hole 303a, thereby enabling the sealing.

Also, as the material member of the packing member, rubber such a silicon and urethane, and thermoplastic elastomer and sponge, such as polystyrene, polyolefins, polyurethanes, polyesters, and polyamide may be used. With using the container main body provided with the sealing member to which the packing member is fixed, the same experiment has been conducted. As a result, the same result as that using the foaming member such as the low foamed polyurethane in the packing member with respect to the sealing property was obtained.

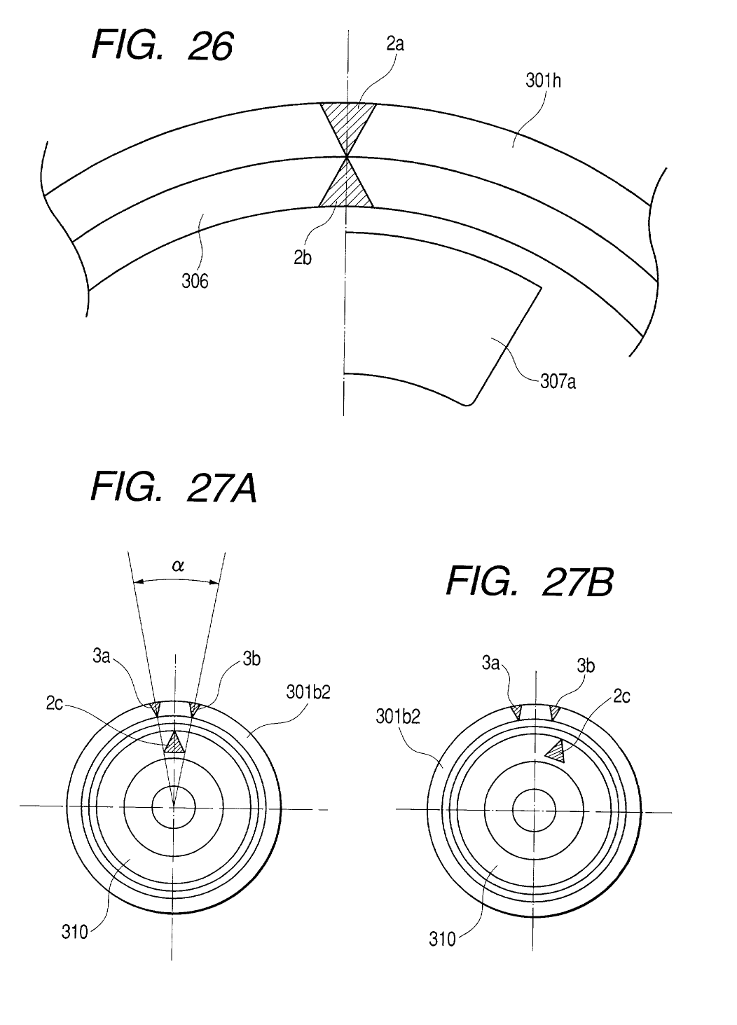

FIG. 26 shows an enlarged right side view showing the toner supplying container to which the embodiment of the present invention is applied and shows a right end side of the agitating member 305 in the axial direction. Referring to FIG. 26, a cylindrical bearing portion 301h (refer to FIG. 9A) projecting from the side wall (end wall) at the right surface side of the container main body 301A is provided with a positioning mark 2a. Also, in the bearing portion 301h, the transmitting member 306 engaged with one end of the agitating member 305 (not shown)(refer to FIGS. 7 and 21A to 21D) is provided with a positioning mark 2b. The positioning mark may be replaced by a member disposed on the surface of the transmitting member 307 such as the transmitting claw portion 307a.

FIGS. 27A and 27B shows a left side enlarged view of the toner supplying container to which the embodiment of the present invention is applied and shows the left end side of the agitating member 305 in the axial direction. Referring to FIGS. 27A and 27B, the cylindrical second receiving portion 301b2 projecting from the side wall (end wall) of the left surface side of the container main body is provided with range marks 3a and 3b. Also, in the second receiving portion 301b2, the stopper member (second bearing member) 310 which is engaged with the other end of the agitating member 305 (not shown) is provided with a positioning mark 2c. The agitating member 305 is so structured as to be assembled only in a state where the transmitting member 306 and the stopper member 310 have a certain directional engaging angle, so that reverse assembling cannot be made. With this structure, the positioning mark can be effectively used to determine as to whether or not the agitating member has an abnormality.

In the structure for achieving the above, since the transmitting member 306 and the stopper member 301 are identical in structure with each other, only the transmitting member 306 will be described.

As shown in FIGS. 21A to 21D, the transmitting member 306 is disposed with a shaft portion 306b, which is hexagonal in section in the center axial direction. The leading edge of the shaft portion 306b is provided with a check claw 306c. The check claw 306c is integrally molded with the shaft portion 306b at the outer peripheral side of the end side of the shaft portion 306b, and a stem 306c1 extends in the axial direction and a claw portion 306c2 is bent at about 180 degrees at the leading edge. The claw portion 306c2 is flexible and enables the leading edge side to approach the stem 306c1.

On the other hand, one end 305d of the shaft portion 305a of the agitating member 305 is provided with a rectangular hole 305d1 into which the claw portion 306c2 can be inserted only in a state where the claw portion 306c2 approaches the stem 306c1. The claw portion 306c2 that has passed through the rectangular hole 305d1 is restored, and the leading edge is moved out of the rectangular hole 305d1, and the transmitting member 306 is fixed to the shaft portion 305a of the agitating member 305.

In the above structure, since the rectangular hole 305d1 is sided to the outer side of the axial center in the radial direction, the check claw 306c enters the rectangular hole 305d1 only in the state shown in FIGS. 21A to 21D but does not enter the rectangular hole 305d1 at a position rotated by 180 degrees and at other positions.

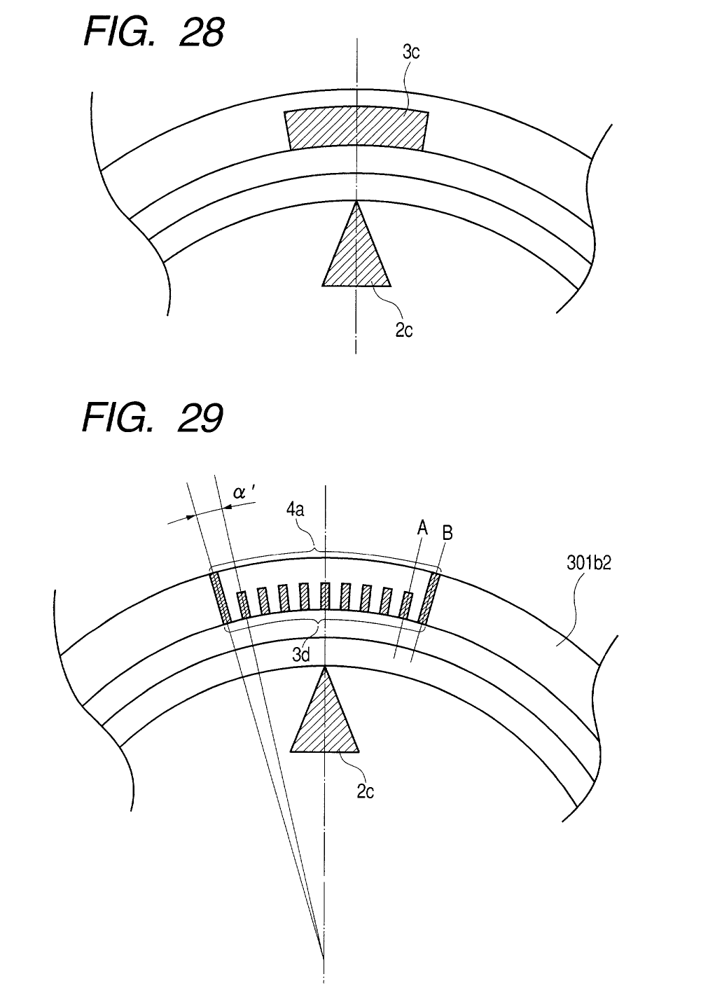

The positioning mark 2c is so set as to be positioned within the angular range between the range marks 3a and 3b as shown in FIG. 27A when the rotating angle position of the positioning mark 2a coincides with the positioning mark 2b. In this example, the range marks 3a and 3b may be one mark indicative of a given angular range as in the mark 3c shown in FIG. 28. It is preferable that an allowable angle range α between the range marks 3a and 3b are set to be about 10 to 30°. More preferably, the allowable angle range is set to be about 20°. In this embodiment, the allowable angle range α is set to be 20°.

Assuming that the toner supplying container thus structured is used and the toner is solidified within the container during circulating transportation, after tapping has been made in a position where the toner supplying container 1 filled with the toner is mounted on the apparatus main body 100, the agitating member 305 is rotated, and a starting torque at that time was measured. Tapping was conducted under the conditions where the toner supplying container 1 is fixed to the tapping table and is then allowed to drop 1000 times continuously at the height of 10 mm and with the vibrating frequency of 2 Hz. As a result, the rotating initial torque of the agitating member 305 became about 30 kgf·cm. Thereafter, all of the toner within the container main body 301A is discharged, the toner supplying container 1 is disassembled, and the contents was recognized. As a result, no abnormality such as the deformation of the agitating member 305 was found. In addition, when the rotating angle position of the positioning mark 2a coincided with the positioning mark 2b, the positioning mark 2c was positioned within the angle range between the range marks 3a and 3b as shown in FIG. 27A. As a result that the toner supplying container 1 was again filled with the toner and the toner was discharged, the amount of remaining toner within the container main body 301A after the discharge has been completed was 30 g. Also, the occurrence of the coarse particles in the discharged toner was not found.

In addition, assuming that the toner is excessively solidified within the container main body 301A rather than the normal toner, after tapping has been made 2000 times in a position where the container main body 301A filled with the toner was mounted on the apparatus main body 100, the agitating member 305 was rotated, and the start torque at that time was measured. The rotating initial torque of the agitating member 305 was about 45 kgf·cm. Thereafter, all of the toner within the container main body 301A was discharged, the container main body 301A was disassembled, and the contents were recognized. As a result, the agitating member 305 was deformed in the circumferential direction of the axis. Further, when the rotating angle position of the positioning mark 2a at one end side of the agitating member 305 in the axial direction has coincided with the positioning mark 2b, the positioning mark 2c of the agitating member 305 at the other end side in the axial direction was out of the angle range between the range marks 3a and 3b shown in FIG. 27B. The container main body 301A was again filled with the toner, and the toner was discharged. As a result, the amount of remaining toner within the container main body 301A after the discharge has been completed was 60 g which was remarkably increased as compared with a case of the toner supplying container where the agitating member 305 was not deformed. Also, a slight amount of coarse particles in the discharged toner was recognized.

Also, when the toner supplying container 1 where the toner has been supplied actually is collected, and the rotating angle position of the positioning mark 2a has coincided with the positioning mark 2b, the container main body 301A where the positioning mark 2c has been positioned within the angle range between the range marks 3a and 3b was again filled with the toner, and the toner was discharged. As a result, the amount of toner within the container main body 301A after the discharge has been completed was the same level as that in an unused product. Also, the occurrence of coarse particles in the discharged toner was not found.

As described above, after the rotating angle position of one end side of the agitating member has coincided with a predetermined position of the container main body, the positional recognition of the other end side of the agitating member and the container main body was conducted according to the range mark indicative of the positioning mark and the predetermined angle range, thereby being capable of determining the abnormality such as the deformation of the agitating member within the container even if the container is not disassembled. As a result, the determination of the possibility of the recycle of the container can be readily conducted.

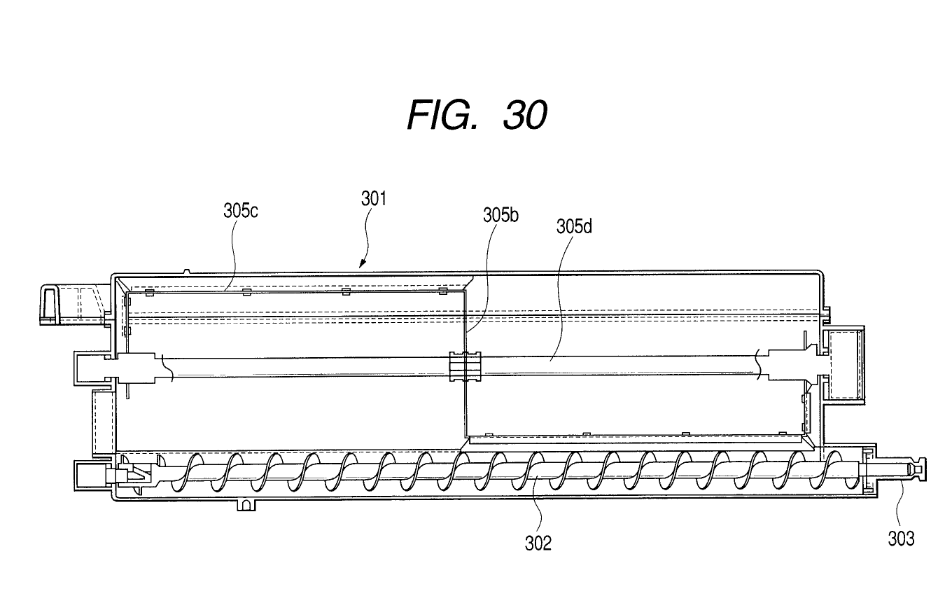

In the above embodiment, the structure in which the coupling member and the stopper member are engaged with both of the end sides of the rotary shaft of the agitating member, and the rotary shaft is pivotally supported to the container main body through those members was described. However, the present invention is not limited to the above structure, but the structure shown in FIG. 30 may be applied.

That is, in FIG. 30, the rotary shaft per se of the agitating member is integrally molded so as to serve as the coupling member and the stopper member. Even in the structure shown in FIG. 30, the same actions and effects can be obtained if the present invention is applied to such a structure. The above structure can be applied to the following embodiment.

(Second Embodiment)

FIG. 29 shows a partially enlarged view of the left side surface of the toner supplying container to which a second embodiment of the present invention is applied. Referring to FIG. 29, graduations 4a are disposes at given angle intervals in a cylindrical second receiving portion 301b2 projecting from the side wall of the container main body 301A at the left side. It is preferable that the angle range α′ at one interval of the graduations 4a are set to be about 1 to 5°. In this embodiment, the angle range α′ is set to be 3°. The other structures are identical with those in the first embodiment.

Assuming that the toner supplying container thus structured is used, and the toner is excessively solidified within the container main body 301A rather than the normal toner, after tapping has been made 1500 times and 2000 times in a position where the toner supplying container 1 filled with the toner was mounted on the apparatus main body 100, the agitating member 305 was rotated, and the start torque at that time was measured. The tapping conditions are identical with those in the first embodiment. As a result, the rotating initial torque of the agitating member 305 was about 40 kgf·cm at the time of tapping 1500 times and about 45 kgf·cm at the time of tapping 2000 times. Thereafter, all of the toner within the container main body 301A was discharged, the container main body 301A was disassembled, and the contents were recognized. As a result, the agitating member 305 was deformed in the circumferential direction of the axis under both of those two conditions, but the degree of deformation at the time of tapping 2000 times was slightly larger. Further, when the rotating angle position of the positioning mark 2a has coincided with the positioning mark 2b, the positioning mark 2c indicates a position of A in the graduations 4a at the time of tapping 1500 times, and indicates position of B at the time of tapping 2000 times. The toner supplying container 1 was again filled with the toner, and the toner was discharged. As a result, the amount of remaining toner within the container main body 301A after the discharge has been completed was 50 g at the time of tapping 1500 times and 60 g at the time of tapping 2000 times. Thus, the amount of remaining toner at the time of tapping 2000 times where the degree of deformation of the agitating member 305 is large is larger. Also, a slight amount of coarse particles in the discharged toner was recognized under both of the conditions.

As described above, the rotating angle position of the bearing member that is engaged with one end of the agitating member is allowed to coincide with a predetermined position of the container main body, and the positional recognition of the bearing member that is engaged with the other end and the container main body is conducted by the graduations where the positioning mark and the predetermined angle intervals are provided, thereby being capable of determining a difference in the degree of deformation of the agitating member even if the toner supplying container is not disassembled. The above values of the. graduations are regarded as the degree of deterioration of the agitating member so that the deterioration circumstance of the respective toner supplying container which has been used can be managed.

(Third Embodiment)

(Method of Remanufacturing Toner Supplying Container)

A method of remanufacturing the toner supplying container from which the toner has been completely consumed.

(a) A toner supplying container includes a toner filling port 301i that serves as an opening portion for filling the toner; a toner supply opening portion 301a that serves as an opening portion for discharging the toner; sealing members 311 and 303 for sealing the above two opening portions 301i and 301a, respectively; and a toner agitating member 305 for agitating the toner contained in the container, in which a transmitting member 306 that serves as a rotating portion which rotates integrally with the rotating portion at both ends of the agitating member 305 or the agitating member 305, and a second bearing member 310 are exposed from the container main body 301A that constitutes the toner containing portion, and inspection marks (refer to the first or second embodiment) are disposed at the rotating portion and at both end sides of the container main body 301A corresponding to the rotating portion.

In this example, the rotating portions of the agitating member 305 at both ends thereof are supported to the holes at both end walls of the container main body 301A in the axial direction (not shown).

Also, both end sides of the container main body 301A corresponding to the above exposed portion is directed to a fixed portion which is at the substantially same position as that of the rotating member in the axial direction of the agitating member 305 as described as the second receiving portion 301b2 disposed on the end wall of the container main body 301A, the bearing portion 301h and so on in the first and second embodiments.

In summary, the toner supplying container from which the toner has been consumed as described in the first and second embodiments is prepared.

(b) A first process is as follows:

The sealing member 311 that tightly seals the toner filling port 301i which is an opening portion for filling the toner and the sealing member 303 that tightly seals the toner supply opening portion 301a which is an opening portion that discharges the toner are taken out from the toner supplying container, respectively. Since those sealing members 303 and 311 are force-fitted into the opening portions 301a and 301i, respectively, they are drawn by using a tool such as a plier or automatically taken out.

(c) Clean the toner supplying container in a second process.

This cleaning, for example, blows a compressed air from the toner filling port 301i and sucks the air from the toner supply opening portion 301a. In this situation, the blowing of the compressed air and the suction of the air are conducted while the agitating member 305 rotates by using a device (not shown) for rotating the agitating member 305. As a result, the residual toner in the toner supplying container 1 is removed. During the above-described cleaning, when a shock is given to the container main body 301A by a hammer or the like, or vibrations are given to the container main body 301A, the toner stuck onto the inner wall of the container main body 301A can be effectively removed.

(d) The abnormality of the agitating member 305 is recognized in a third process. As was already mentioned above, on one end side of the container main body 301A, after the positioning marks 2a and 2b of the second coupling member 306 are allowed to coincide with each other, it is checked whether the positioning mark 2c of the second bearing member (stopper member) 310 exists within the range graduations 3a and 3b at the other end side of the container main body 301A, or not. If it is within the range graduations 3a and 3b, the following process is continued whereas if it is out of the range graduations 3a and 3b, the damages of the agitating member 305 and the peripheral portion thereof are presumed, remanufacture is made by resource restoration or another remanufacturing method (its description will be omitted).

In this example, when the positioning mark 2c is out of the range marks 3a and 3b, the damage of the following portions is presumed.

(1) The deformation of the coupling portion of the transmitting member 306 with the shaft portion 305a of the agitating member 305

(2) The twist of the agitating shaft 305a

(3) The deformation of the coupling portion of the shaft portion 305a of the agitating member 305 with the second bearing member 310. In case of the above (1) and (2), the damage is caused by a case in which the agitating load exerted on the agitating member 305 is large, or a case in which the torque load becomes excessive due to an increase in the frictional force between the second bearing member 310 and the second receiving portion 301b2.

In case of the above (3), the damage is caused by an increase in the torque load due to an increase in frictional force between the second bearing member 310 and the second receiving portion 301b2.

The examination of the agitating member 305 is made according to the first embodiment, but may be made according to the second embodiment which was already mentioned.

(e) The toner supply opening portion 301a is sealed with the sealing member 303 in a fourth process. The sealing is executed by catching the sealing member 303 by a plier or the like and force-fitting the sealing member 303 into the toner supply opening portion 301a.

(f) The toner is filled in the toner supplying container 1 from the toner filling port 301i in a fifth process. The toner filling is conducted by using a constant-quantity supply device.

(g) The sealing member 311 is fitted onto the toner filling port 301i in a sixth process. The fitting of the sealing member 311 is conducted by lightly force-fitting the sealing member 311 into the toner filling port 301i. That is, the sealing member 311 is force-fitted into the toner filling port 301i by using a press machine.

In this embodiment, the abnormality of the agitating member 305 is recognized, but the present invention is not limited this structure. It is preferable that the process of recognizing the abnormality of the agitating member is conducted after the cleaning process in which the toner within the container main body is removed. This is because there are a case where a large amount of toner remains in the toner supplying container which has been collected for remanufacture and a case where a large amount of toner does not remain therein. In other words, if the recognizing process is conducted prior to the cleaning process, there is a fear that it is determined that the agitating member is abnormal due to the remaining toner even if no abnormality occurs in the agitating member. Therefore, if the recognizing process is conducted after the cleaning process, since the conditions of the toner supplying container in the recognizing process can be made to coincide with each other, the abnormality can be recognized and determined excellently.

With the above operation, the toner supplying container is remanufactured.

In this way, when the toner supplying container is remanufactured, the damage on the agitating member or its support portion can be informed of without disassembling the container main body.

With the use of the above-mentioned remanufacturing method, the abnormality such as the deformation of the agitating member packed in the container main body can be visually recognized from the external, and it can be readily determined whether the toner supplying container can be remanufactured, or not.

In the above-described embodiments, the toner supplying container supplies the toner to the image forming apparatus. However, the present invention is not limited to this structure, for example, if the image forming apparatus is so structured as to form an image by using a developer having toner and carrier, the toner supplying container may be structured to receive the toner and the carrier which are supplied to the image forming apparatus.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A toner container detachably mountable on an image forming apparatus, said toner container comprising:
a containing portion for containing toner therein;
an agitating member disposed within said containing portion and for agitating the toner within said containing portion; and
a first and a second rotating portions that rotate together with a rotary shaft of said agitating member at both end sides of said rotary shaft, said first and second rotating portions being exposed to an exterior of said containing portion,
wherein said containing portion includes a first mark at a position corresponding to a predetermined position of said first rotating portion and a second mark at a position corresponding to a predetermined position of said second rotating portion.

2. A toner container according to claim 1, wherein said first and second rotating portions are engaged with said rotary shaft, respectively, and said first and second rotating portions are pivotally supported by said containing portion.

3. A toner container according to claim 2, wherein said rotary shaft has restricting portions that restricts an engaging angle of said first and second rotating portions with respect to said rotary shaft at both end sides thereof, respectively.

4. A toner container according to claim 2, wherein a third mark is disposed at said predetermined position of said first rotating portion.

5. A toner container according to claim 4, wherein said first rotating portion has an engaging portion which is engaged with the image forming apparatus.

6. A toner container according to claim 5, wherein said engaging portion is said third mark.

7. A toner container according to claim 5, wherein said first rotating portion has a transmitting portion that transmits a drive force from the image forming apparatus to said rotary shaft in a state where said engaging portion is engaged with the image forming apparatus.

8. A toner container according to claim 4, wherein a fourth mark is disposed at said predetermined position of said second rotating portion.

9. A toner container according to claim 8, wherein said second mark or said fourth mark is disposed to indicate a predetermined angle range.

10. A toner container according to claim 9, wherein said fourth mark is disposed to indicate a predetermined angle range.

11. A toner container according to claim 10, wherein graduations are provided within said predetermined angle range.

12. A toner container according to claim 2, wherein said first rotating portion and said second rotating portion are a portions of said rotary shaft, and said rotary shaft is pivotally supported by said containing portion through said first and second rotating portions.

13. A toner container according to claim 1, wherein said containing portion contains the toner which is supplied to the image forming apparatus in a state where said toner container is mounted on the image forming apparatus.

14. A toner container according to claim 1, wherein said agitating member rotates to be in contact with an inner wall of said containing portion.

15. A toner container according to claim 1, wherein before said toner container is used, when said first rotating portion rotates so that said predetermined position of said first rotating portion faces said first mark, said predetermined position of said second rotating portion substantially faces said second mark.

16. A toner container according to claim 15, wherein said first rotating portion has a receiving portion that receives a force that allows said first rotating portion to rotate so that said predetermined position of said first rotating portion faces said first mark.

17. A toner container according to claim 16, wherein said receiving portion is shaped in a protrusion.

18. A toner container according to claim 1, wherein said first and second marks are used to determine an abnormality of said agitating member.

19. A method of determining an abnormality of a toner container detachably mountable on an image forming apparatus, said toner container comprising a containing portion for containing toner therein; an agitating member disposed within said containing portion and for agitating the toner within said containing portion; and a first and a second rotating portions that are exposed to the exterior of said containing portion and rotate together with a rotary shaft of said agitating member at both end sides of said rotary shaft; wherein said containing portion includes a first mark at a position corresponding to a predetermined position of said first rotating portion and a second mark at a position corresponding to a predetermined position of said second rotating portion, said method comprising the steps of:
rotating said first rotating portion so that said predetermined position of said first rotating portion faces said first mark; and
recognizing whether said predetermined position of said second rotating portion substantially faces said second mark, or not, in order to determine the abnormality of said agitating member in a state where said rotating step has been conducted.

20. A method according to claim 19, wherein said recognizing step is conducted for remanufacturing said toner container which has been used.

21. A method according to claim 20, further comprising a step of cleaning said containing portion;
wherein said recognizing step is conducted after said cleaning step.

22. A method according to claim 20 or 21, wherein if it is determined that there is no abnormality in said agitating member in said recognizing step, a filling step of filling said containing portion with the toner is conducted without exchanging said agitating member.

23. A method according to claim 19, wherein before said toner container is used, when said first rotating portion rotates so that said predetermined position of said first rotating portion faces said first mark, said predetermined position of said second rotating portion substantially faces said second mark.

24. A method according to claim 19, wherein said first and second rotating portions are engaged with said rotary shaft, respectively, and said first and second rotating portions are pivotally supported by said containing portion.

25. A method according to claim 24, wherein said rotary shaft has restricting portions for restricting engaging angles of said first and second rotating portions with respect to said rotary shaft at both end sides of said rotary shaft, respectively.

26. A method according to claim 24, wherein a third mark is disposed at said predetermined position of said first rotating portion.

27. A method according to claim 26, wherein said first rotating portion has an engaging portion which is engaged with the image forming apparatus.

28. A method according to claim 27, wherein said engaging portion is said third mark.

29. A method according to claim 27, wherein said first rotating portion has a transmitting portion that transmits a drive force from the image forming apparatus to said rotary shaft in a state where said engaging portion is engaged with the image forming apparatus.

30. A method according to claim 26, wherein a fourth mark is disposed at said predetermined position of said second rotating portion.

31. A method according to claim 30, wherein said second mark or said fourth mark is disposed to indicate a predetermined angle range.

32. A method according to claim 31, wherein said fourth mark is disposed to indicate a predetermined angle range.

33. A method according to claim 32, wherein graduations are provided within said predetermined angle range.

34. A method according to claim 24, wherein said firsaid first rotating portion and said second rotating portion are portions of said rotary shaft, and said rotary shaft is pivotally supported by said containing portion through said first and second rotating portions.

35. A method according to claim 19, wherein said containing portion contains the toner which is supplied to the image forming apparatus in a state where said toner container is mounted on the image forming apparatus.

36. A method according to claim 19, wherein said agitating member rotates to be in contact with an inner wall of said containing portion.
